(19) United States
(12) Patent Application Publication
(10) Pub. No.: US 2025/0164665 A1
(43) Pub. Date: May 22, 2025

(54) OMNI-DIRECTIONAL ATMOSPHERIC SENSOR AND RELATED METHODS

(71) Applicant: KNIGHTWERX INC., Camarillo, CA (US)

(72) Inventors: Daniel Baumgartner, Santa Rosa Valley, CA (US); Henry Won, Ithaca, NY (US); Benjamin Pipenberg, Moorpark, CA (US)

(21) Appl. No.: 18/948,229

(22) Filed: Nov. 14, 2024

Related U.S. Application Data
(60) Provisional application No. 63/600,276, filed on Nov. 17, 2023.

(51) Int. Cl. G01W 1/04; B64U 20/80; B64U 101/35; F41G 3/08; G01L 19/00

(52) U.S. Cl. CPC G01W 1/04; B64U 20/80; G01L 19/0092; B64U 2101/35; F41G 3/08

(57) ABSTRACT

An atmospheric measurement device includes an atmospheric probe having an aerodynamical profile defined by an outer surface, a plurality of ports extending through the outer surface and an inner surface of the atmospheric probe, and a plurality of pressure sensors. Each pressure sensor of the plurality of pressure sensors positioned within the atmospheric probe and adjacent a respective one of the plurality of ports. Each pressure sensor of the plurality of pressure sensors is configured in sealing engagement with the respective one of the plurality of ports.

### RELATED APPLICATIONS

This application claims priority to and the benefit of the filing date of U.S. Provisional Application No. 63/600,276, entitled “OMNI-DIRECTIONAL ATMOSPHERIC SENSOR AND RELATED METHODS,” filed Nov. 17, 2023, which is incorporated by reference herein in its entirety.

### TECHNICAL FIELD

The present disclosure relates generally to atmospheric sensors and more specifically to systems and methods of real-time measuring, mapping, tracking, and/or predicting atmospheric data relative to the devices own physical orientation, state, location, and motion in 3D space.

### BACKGROUND

Environmental forces such as wind speed, wind direction and other atmospherics (e.g., barometric pressure, temperature, humidity) can drastically affect the flight path of an object, energy, or frequency beam (e.g., ballistic projectiles, airdrops, aircraft, laser, equipment drops, skydive jumps, etc.) through space. The flight path can be affected by highly complex wind conditions in which inconsistent wind speeds, wind directions and other atmospherics make precision placement difficult.

Known wind sensors include cup anemometers, ultrasonic sensors, wind vanes, handheld impellers, lidar systems, hot-wire sensors, and pitot tubes. While these known wind measurement devices may be used to estimate wind speed, they can be prone to error, particularly in gauging multi-directional wind direction. Moreover, many known wind sensors are susceptible to error when the sensor itself is moving, thereby influencing measured wind speed and/or direction. Moving mechanical parts such as rotational bearings can experience wear and can be susceptible to variation in operation caused by temperature fluctuations.

Additionally, distributing multiple wind sensors in an area of operation may be difficult, if not impractical, in many applications such as when time is of the essence or discreteness is desired.

It is therefore desirable to provide improved systems and methods that address at least in part the above described problems and/or which more generally offers improvements or an alternative to existing wind and atmospheric sensors.

### SUMMARY

According to an aspect of the present disclosure, an atmospheric measurement device may include an atmospheric probe having a spherical profile or aerodynamically shaped profile defined by an outer surface, a plurality of ports extending through the outer surface and an inner surface of the atmospheric probe, and a plurality of pressure sensors. Each pressure sensor of the plurality of pressure sensors may be positioned within the atmospheric probe and adjacent to a respective one of the plurality of ports. Each pressure sensor of the plurality of pressure sensors may be configured in sealing engagement with the respective one of the plurality of ports.

In some embodiments, the plurality of pressure sensors may be arranged about the spherical profile or aerodynamically shaped profile in a manner enabling the atmospheric measurement device to determine a first angle of a wind direction through a range of 360° about a vertical axis of the atmospheric probe and a second angle of the wind direction through a range of ±30° about a horizontal axis of the atmospheric probe.

In some embodiments, the plurality of ports may be arranged in a first row positioned in an upper hemisphere of the atmospheric probe and a second row positioned in a lower hemisphere of the atmospheric probe. Each of the first and second rows may include six ports spaced equidistantly apart about a vertical axis of the atmospheric probe. The first row may be positioned approximately 20° above a reference plane separating the upper and lower hemispheres and the second row may be positioned approximately 20° below the reference plane. The plurality of ports may further include a third row positioned in the upper hemisphere of the atmospheric probe. The third row may include four ports spaced equidistantly apart about the vertical axis of the atmospheric probe.

In some embodiments, the plurality of pressure sensors may be mounted to a sensor substrate positioned within the atmospheric probe. The sensor substrate may include a base positioned within a lower hemisphere of the atmospheric probe and a plurality of legs extending from the base into an upper hemisphere of the atmospheric probe.

In some embodiments, an atmospheric measurement device may include a hand-held housing from which the atmospheric probe extends, a primary substrate positioned within the housing, a processor and a memory disposed on the primary substrate, a 9DOF (degrees of freedom) module, buttons, a user interface, and a display. The processor may be configured to receive a signal from each of the plurality of pressure sensors and to calculate a wind direction and a wind speed based on the signals. The display may be configured to display the wind direction and the wind speed. A humidity sensor may be disposed within the housing. A mounting interface may be disposed at least partially within the housing.

In some embodiments, an atmospheric measurement device may include a weapon-mount configured to secure the atmospheric probe to a firearm, or other military system, or observation device, such as spotter scope, remote camera, monocular, or binocular.

According to an aspect of the present disclosure, an unmanned aerial vehicle may include a fuselage, at least one fixed wing, a propulsion system, and an atmospheric measurement device. The atmospheric measurement device may be mounted to a top surface or a bottom surface of the fuselage. The atmospheric measurement device may be disposed within a cargo bay in the fuselage. The atmospheric measurement device may be mounted to a nose of the fuselage or rotating and extending payload mechanism.

According to an aspect of the present disclosure, an unmanned aerial vehicle may include a fuselage, a plurality of rotary wings, and an atmospheric measurement device. The atmospheric measurement device may be mounted to the fuselage.

According to an aspect of the present disclosure, a field deployable node may include an atmospheric measurement device and a tripod supporting the atmospheric measurement device. A field deployable node may include an atmospheric measurement device and a parachute supporting the atmospheric measurement device. A field deployable node may include an atmospheric measurement device, a tripod secured to the atmospheric measurement device, and a parachute secured to the atmospheric measurement device or the tripod. A field deployable node may include an atmospheric measurement device and a stake secured to the atmospheric measurement device. The stake may be configured to penetrate ground and support the atmospheric measurement device above ground level when the node is dropped from an aircraft.

According to an aspect of the present disclosure, a targeting system may include a weapon, a ballistics computer, and a plurality of nodes configured to be deployed across an area of operation. At least one node of the plurality of nodes may include an atmospheric measurement device. Each node of the plurality of nodes may be configured to obtain atmospheric data at a respective deployment location and transmit the atmospheric data to the ballistics computer. The ballistics computer may be configured to calculate a ballistic solution based on aggregated atmospheric data obtained from the plurality of nodes.

According to an aspect of the present disclosure, an unmanned aerial vehicle may include a body, a plurality of pressure sensors integrated into the body at a plurality of distributed ports, and a processor configured to obtain pressure data from the plurality of pressure sensors and to calculate a wind speed and a wind direction based on the pressure data and a known location of each pressure sensor of the plurality of pressure sensors in relation to the body.

In some embodiments, the body may include two or more structures selected from a group consisting of a fuselage, at least one wing, at least one more housing, at least one rotor hub, and a vertical stabilizer. The plurality of pressure sensors may be distributed across a plurality of the two or more structures.

In some embodiments, the body may include a fuselage and at least one wing. At least a portion of a first group of pressure sensors of the plurality of pressure sensors may be disposed across a leading side of the body and at least a portion of a second group of pressure sensors of the plurality of pressure sensors may be disposed across a tailing side of the body. The body may include a vertical stabilizer and at least one pressure sensor of the first group and at least one pressure sensor of the second group may be disposed in the vertical stabilizer. The body may include a rotor assembly and at least one pressure sensor of the first group and at least one pressure sensor of the second group may be disposed in the rotor assembly.

In some embodiments, the body may include a fuselage. The plurality of pressure sensors may be distributed about the fuselage. The plurality of pressure sensors may include a first row of pressure sensors and a second row of pressure sensors. The first and second rows may each extend circumferentially around the fuselage.

In some embodiments, the body may include a rocket. The body may be configured to be tethered to an anchor. The plurality of pressure sensors may be integrated into a nosecone of the rocket.

In an aspect of the present disclosure, a weapon system includes a firearm, a ballistics computer, and an atmospheric measurement device mounted to the firearm. The atmospheric measurement device may include an atmospheric probe, a plurality of ports extending through an outer surface of the atmospheric probe, and a plurality of pressure sensors. Each pressure sensor of the plurality of pressure sensors may be positioned within the atmospheric probe and adjacent a respective one of the plurality of ports.

In some embodiments, the atmospheric measurement device may be configured to collect raw data regarding an atmospheric wind and transmit the raw data to the ballistics computer. The atmospheric measurement device may be configured to calculate a wind speed and a wind direction of an atmospheric wind and transmit the calculated wind speed and wind direction to the ballistics computer.

In some embodiments, the atmospheric measurement device may be mounted to the firearm or observation device with a base secured to a rail adapter. The base may include a pivotable and telescopic mast configured to transition from a stowed configuration in which the mast is oriented parallel to an accessory rail of the firearm and a deployed configuration in which the mast is oriented perpendicular to the accessory rail. The mast may be extendable.

In some embodiments, the atmospheric measurement device may be configured to wirelessly transmit wind data to the ballistics computer. The atmospheric measurement device may be configured to transmit atmospheric data to the ballistics computer via a wired connection.

In some embodiments, the ballistics computer may include a handheld computing device. The ballistics computer may include a heads-up display mounted to the firearm.

In some embodiments, the atmospheric measurement device may be a field deployable node. The node may be configured to wirelessly transmit atmospheric data to the ballistics computer or user interface or receiving device.

In some embodiments, the ballistics computer may be configured to receive atmospheric data and position data from a plurality of atmospheric sensors, including the atmospheric measurement device mounted to the firearm, and to calculate a ballistic solution for a projectile based on the atmospheric data and position data. The plurality of atmospheric sensors may include at least one airborne atmospheric sensor. The plurality of atmospheric sensors may include at least one field deployable node. Each atmospheric sensor of the plurality of atmospheric sensors may be configured to transmit atmospheric data to the ballistics computer.

Additional features are set forth in part in the description that follows and will become apparent to those skilled in the art upon examination of the specification, claims, and drawings or may be learned by the practice of the disclosed subject matter. A further understanding of the nature and advantages of the present disclosure may be realized by reference to the remaining portions of the specification and the drawings, which forms a part of this disclosure.

One of skill in the art will understand that each of the various aspects and features of the disclosure may advantageously be used separately in some instances, or in combination with other aspects and features of the disclosure in other instances. Accordingly, individual aspects can be claimed separately or in combination with other aspects and features. Thus, the present disclosure is merely exemplary in nature and is in no way intended to limit the claimed invention or its applications or uses. It is to be understood that structural and/or logical changes may be made without departing from the spirit and scope of the present disclosure.

The present disclosure is set forth in various levels of detail and no limitation as to the scope of the claimed subject matter is intended by either the inclusion or non-inclusion of elements, components, or the like in this summary. In certain instances, details that are not necessary for an understanding of the disclosure or that render other details difficult to perceive may have been omitted. Moreover, for the purposes of clarity, detailed descriptions of certain features will not be discussed when they would be apparent to those with skill in the art so as not to obscure the description of the present disclosure. The claimed subject matter is not necessarily limited to the arrangements illustrated herein, with the scope of the present disclosure is defined only by the appended claims.

### BRIEF DESCRIPTION OF THE DRAWINGS

The description will be more fully understood with reference to the following figures in which components may not be drawn to scale.

FIGS. 1A-1F illustrate an example of a handheld atmospheric measurement device in accordance with an embodiment of the disclosure.

FIGS. 2A-2B illustrate an example of an atmospheric probe in accordance with an embodiment of the present disclosure.

FIGS. 3A-3D illustrate examples of pressure simulations of atmospheric probes

FIGS. 4A-4C illustrate additional examples of handheld atmospheric measurement devices and atmospheric probes

FIG. 5 illustrates an example graphical user interface of an atmospheric measurement device.

FIG. 6 illustrates data communication between a plurality of atmospheric measurement devices.

FIGS. 7-8 illustrate examples of integrated covers of atmospheric probes.

FIGS. 9A-9D illustrate examples of unmanned aerial vehicles incorporating an atmospheric probe.

FIGS. 10A-10B illustrate examples of unmanned aerial vehicles with integrated sensing ports in accordance with an embodiment of the present disclosure.

FIGS. 11A-11B illustrate an example of an atmospheric probe incorporated into a stationary field deployable sensor unit in accordance with an embodiment of the present disclosure.

FIGS. 12A-12B illustrate an example of an atmospheric probe incorporated into an aerial deployable sensor unit in accordance with an embodiment of the present disclosure.

FIG. 13 illustrates an example of a rocket with integrated sensing ports in accordance with an embodiment of the present disclosure.

FIG. 14 illustrates an example of a targeting system including a swarm of unmanned aerial vehicles incorporating atmospheric probes in accordance with an embodiment of the present disclosure.

FIGS. 15A-15B illustrate an example of a weapon-mounted atmospheric probe in accordance with an embodiment of the present disclosure.

FIGS. 16-17 illustrate an example of a weapon system including an atmospheric probe and Heads-Up Display HUD in accordance with an embodiment of the present disclosure.

FIGS. 18-19B illustrate another example of a weapon system including an atmospheric probe in accordance with an embodiment of the present disclosure.

FIG. 20 illustrates an example of a ballistic calculation system utilizing various deployable atmospheric probes in accordance with an embodiment of the present disclosure.

FIGS. 21A-21C illustrate an example of an atmospheric probe module in accordance with an embodiment of the present disclosure.

FIG. 22 illustrates an example of an atmospheric probe module with a range finder device.

FIGS. 23A-23B illustrate examples of a weapon-mounted atmospheric probe module.

FIG. 24 illustrates an example of an optics-mounted atmospheric probe module.

FIG. 25 illustrates an example application of terrain modeling in calculating a ballistic solution.

FIGS. 26A-26B illustrate example methods for calculating a ballistic solution.

FIG. 27 illustrates an example of a submersible-mounted atmospheric probe module.

FIG. 28 illustrates an example of a PPE-mounted atmospheric probe module.

FIG. 29 illustrates an example of a sports application of an atmospheric probe module.

FIG. 30 illustrates an example of a mobile device compatible atmospheric probe module.

Embodiments of the disclosure and their advantages are best understood by referring to the detailed description that follows. It should be appreciated that like reference numerals may be used to identify like elements illustrated in one or more of the figures.

### DETAILED DESCRIPTION

The present application is directed to a multi-directional atmospheric measurement device which is suitable for measuring three dimensional characteristics such as speed and direction of fluid flow and is particularly suitable for measuring wind. In some embodiments, the present disclosure combines multi-directional wind measurements with device-internal 9DOF sensor module (3 degrees each of acceleration, magnetic orientation, and angular velocity) plus GPS to further calculate the measured atmospheric conditions relative to the devices physical state, motion, acceleration, and position in 3D space, relative to earth, earth magnetism, cosmic star constellations, topographic landscapes, or other reference systems connected to the device. It will be appreciated in the context of the description which follows that by three dimensional is meant that the fluid velocity is measured about three orthogonal axes (x, y and z). It will be appreciated from the description that follows that there are a number of different features, some of which provide an advantage on their own and others which provide an advantage in combination with one or more other features. These features are employed in a measurement device deployable to enhance atmospherics measuring, mapping, and prediction in a multi-dimensional environment. The atmospheric measurement device may, in some examples, further include a self-learning artificial intelligence/machine learning feature that allows the sensor to predict atmospheric conditions based on past experience and data in combination but not limited to the orientation parameters provided by the 9DOF and GPS module, or an external orientation data feed or data input.

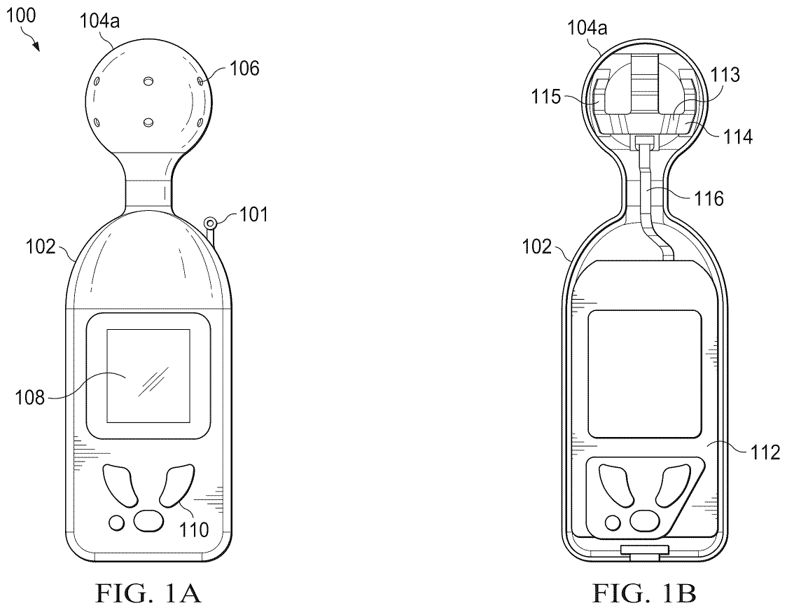

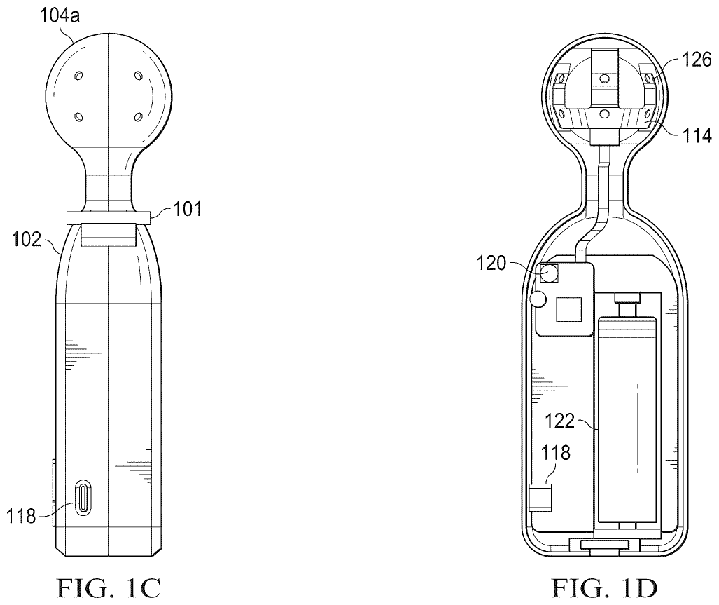

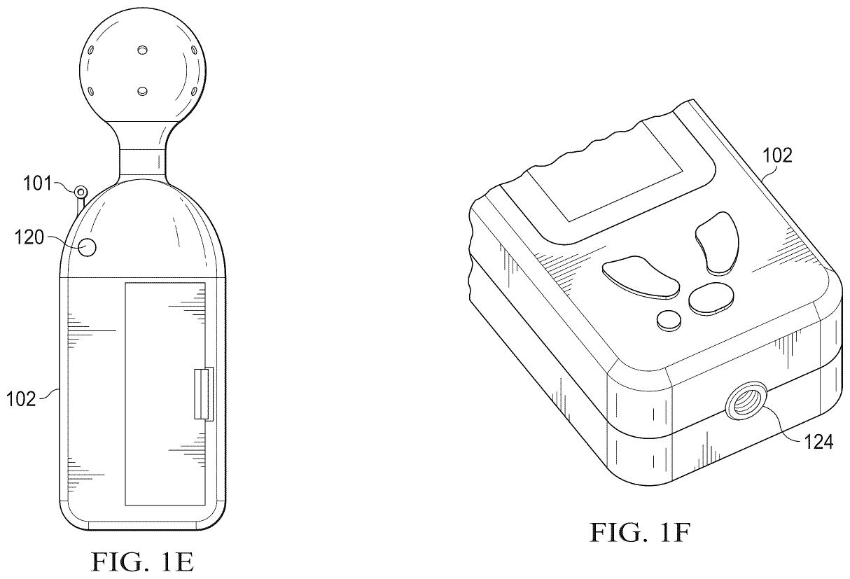

FIGS. 1A-1F illustrate an example of a handheld atmospheric measurement device in accordance with an embodiment of the disclosure. The atmospheric measurement device 100 includes a housing 102 configured to be hand-held by a user. An alignment feature 101 is included on the housing 102. In the illustrated example, the alignment feature 101 is a hollow tubular member. A user may utilize the alignment feature 101 to visually orient the atmospheric measurement device 100 in relation to a vector of interest. An atmospheric probe 104a extends from the housing 102 and is configured to measure a wind speed and/or a wind direction of an atmospheric wind. A plurality of ports 106 are disposed about an aerodynamic profile defined by an outer surface of the atmospheric probe 104a. The aerodynamic profile may be entirely or partially spherical and/or cylindrical. In some examples, the aerodynamic profile includes a concave recess. Each port 106 extends to a corresponding pressure sensor 126 positioned within an inner chamber of the atmospheric probe 104a.

Each pressure sensor may be an absolute pressure sensor, a differential pressure sensor, a relative pressure sensor, or a flow type sensor. For example, each pressure sensor may be configured to measure an absolute pressure at the respective port 106, may be configured to measure a pressure relative to an ambient pressure, and/or the pressure sensors may be arranged in operative pairs or groups and a pressure differential may be measured between two or more grouped pressure sensors. Each pressure sensor may include one or more of a piezoelectric transducer, an electrostatic transducer, or any other suitable type of pressure-sensing mechanism. The plurality of pressure sensors may be positioned on a sensor substrate 114 disposed at least partially within the atmospheric probe 104a. The sensor substrate 114 includes a base 113 and a plurality of legs 115 extending therefrom. At least one pressure sensor is disposed on each leg 115 and a plurality of pressure sensors are disposed on the base 113. Other configurations of the sensor substrate 114 are contemplated such as two bases each extending substantially circumferentially around an inner surface of the probe 104a with each pressure sensor disposed on one of the two bases and a connector extending between the two bases.

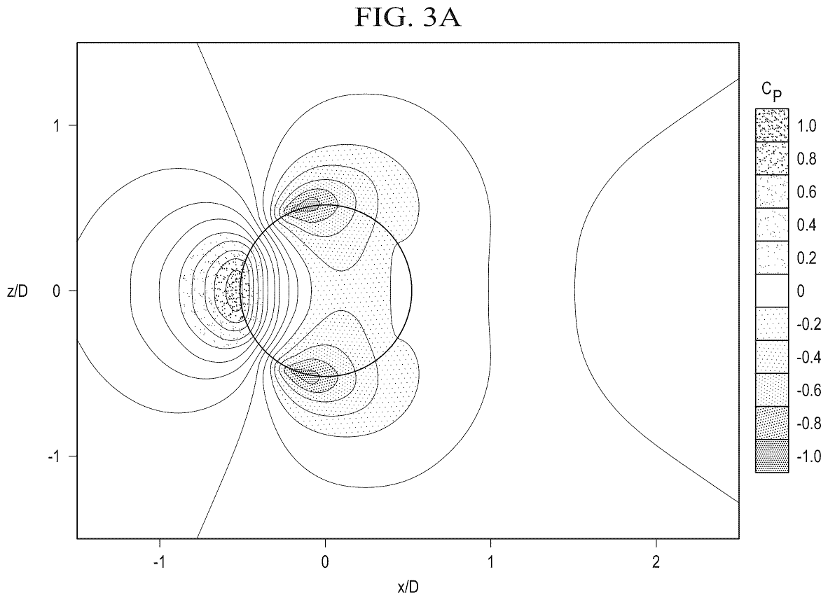

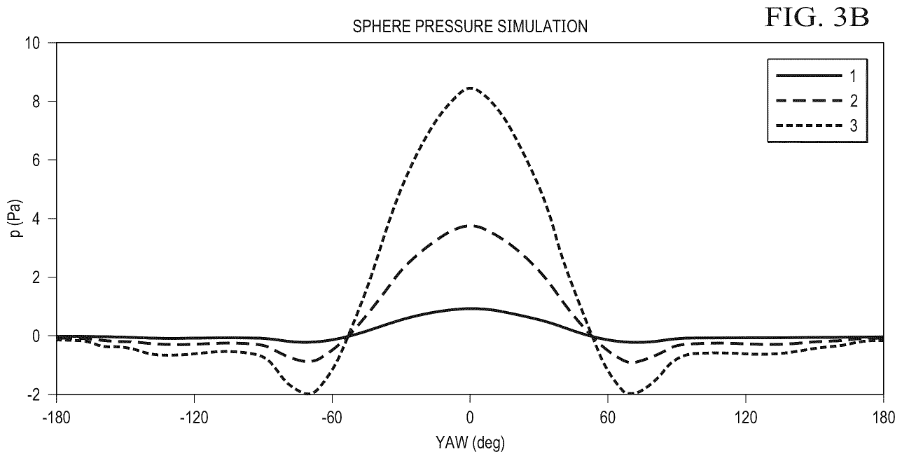

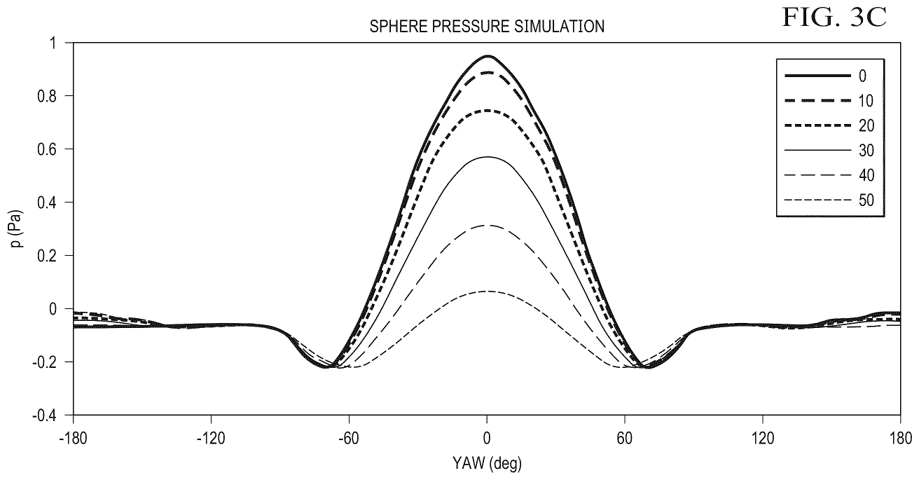

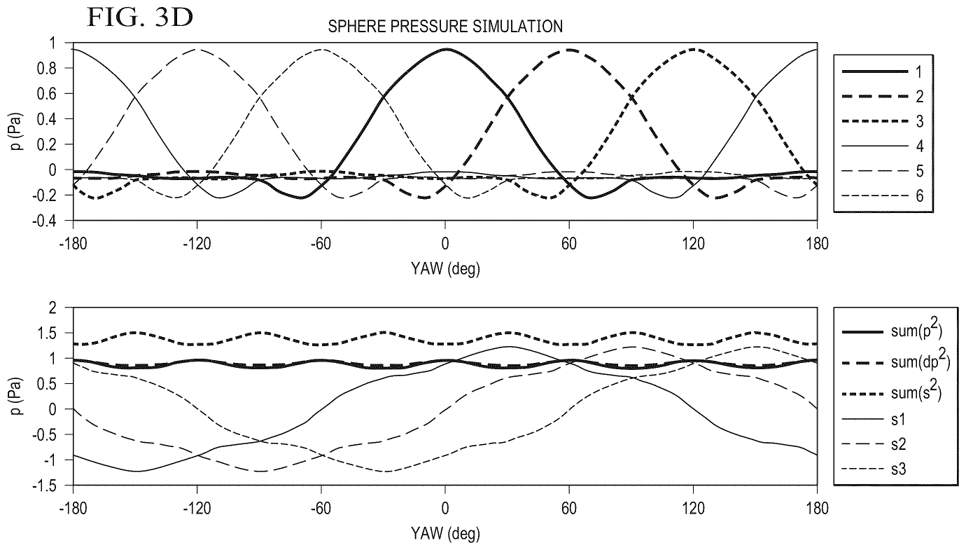

A display 108 may be connected to a primary substrate 112 positioned within the housing 102. A processor and a memory may also be positioned on the primary substrate 112 or elsewhere within the atmospheric measurement device 100. The processor may be configured to receive a signal from each pressure sensor through a data cable 116, such as a ribbon cable, extending between the sensor substrate 114 and the primary substrate 112. A location of each pressure sensor and/or associated port 106 may be stored in the memory along with an algorithm for calculating a wind speed and/or wind direction from the signals from the pressure sensors, as discussed further in relation to FIG. 3A below.

A user interface 110 is also connected to the primary substrate 112 and includes a plurality of buttons extending through the housing to receive user inputs. It will be appreciated that in some embodiments, the user interface 110 may be incorporated into the display 108 as a touchscreen interface. The user interface 110 may be used to invoke algorithms stored in the memory, such as a wind measurement algorithm or a calibration algorithm, as well as to access stored wind measurement data, to input options selections, environmental parameters, etc.

The atmospheric measurement device 100 may include additional atmosphere measurement sensors such as a humidity sensor 120. The humidity sensor 120 may obtain an atmospheric humidity measurement and calibrate pressure readings from the pressure sensors 126 in accordance therewith. The device 100 may also include a thermometer for measuring an ambient temperature. The device sensor data may be combined to calculate density altitude values for respective environmental conditions.

In some embodiments, the atmospheric measurement device 100 includes a 9 degree-of-freedom (“9DOF”) sensor and a location sensor operable to define a location and/or orientation. For example, 9 DOF sensor may define X, Y, and Z components of a vector defining the position and orientation of the device. The location sensor may define a location of the device in relative space, such as GPS latitude/longitude. The 9DOF sensor may include an inertial measurement unit (“IMU”) that includes a gyroscope, an accelerometer, and/or a magnetometer allowing the 9DOF sensor to capture nine distinct types of motion or orientation-related data: 3 degrees each of acceleration, magnetic orientation, and angular velocity. In some embodiments, the atmospheric measurement device 100 includes a 6 degree-of-freedom (“6DOF”) sensor operable to define a location and/or orientation. For example, 6 DOF sensor may define X, Y, and Z components of a vector defining the position and orientation of the device. In some embodiments, the atmospheric measurement device 100 includes a compass configured to determine a magnetic orientation. It is contemplated that the atmospheric measurements device 100 may include any combination or none of the sensors noted above. These sensors may be used to calculate an inclination and/or orientation of the device with respect to the earth, for example, a horizontal heading and vertical pitch. With the known inclination and/or orientation, measured wind direction can be displayed in relation to the earth's surface (e.g., wind at 1:00 and upward at 10°).

A mounting interface 124 is positioned in bottom side of the housing 102, although it will be appreciated that the mounting interface 124 may be positioned at any suitable position. The illustrated example of a mounting interface 124 is an internally threaded bore configured to receive a screw. The mounting interface 124 may be used to mount the atmospheric measurement device to a suitable support structure, such as a tripod.

The atmospheric measurement device 100 may be used independently to measure an atmospheric wind at a discrete location of the device or may include a transmitter or a transceiver for one-way or two-way communication with an external computing device for use in calculating a wind map of a larger area in conjunction with additional atmospheric sensors.

The atmospheric measurement device 100 includes a battery 122 which may be disposable or rechargeable. A power and/or data port 118 is in operable communication with the primary substrate 112 and may be used to charge the battery 122, to export recorded data to an external device, or to import calibration data to the memory.

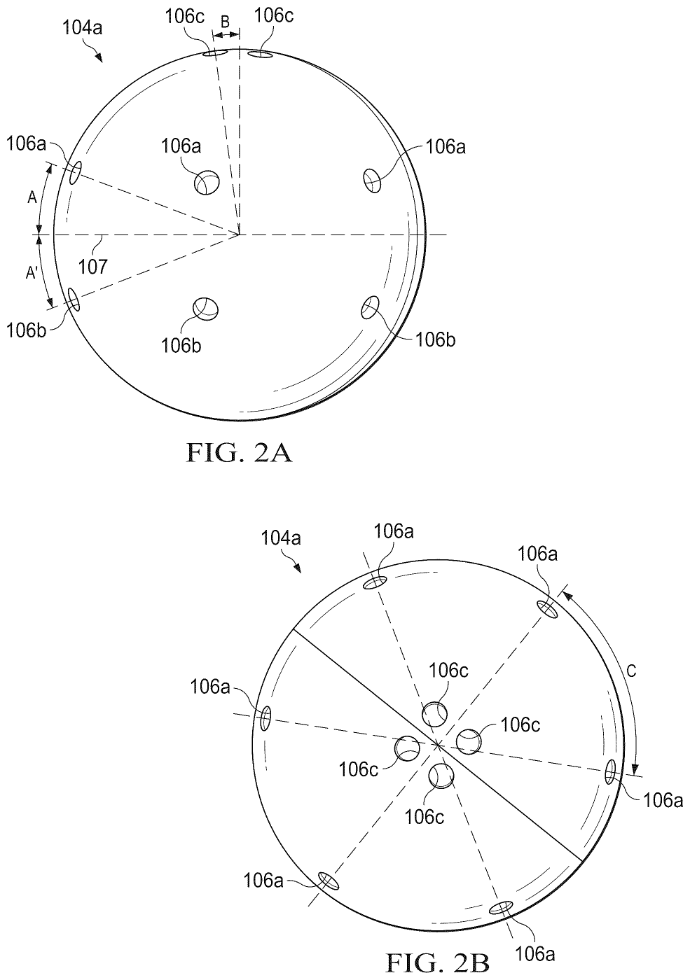

FIG. 2A illustrates a side view of an atmospheric probe 104a in isolation and FIG. 2B illustrates a top view of the atmospheric probe 104a. The external profile of the atmospheric probe 104a is substantially spherical. This shape aids in minimizing disturbances to wind flow that may be caused by abnormally shaped obstructions, although other shapes are possible. A reference plane 107 is shown which divides the atmospheric probe 104a into an upper hemisphere and a lower hemisphere. A first group of ports 106a is positioned circumferentially around the upper hemisphere at a location A above the reference plane 107 and a second group of ports 106b is positioned around the lower hemisphere at a location A′ below the reference plane. A pressure differential between the first group of ports 106a and the second group of ports 106b may be used to determine a vertical component of a wind direction. The value of A and A′ are typically equal but may also be different in some embodiments. The value of A and/or A′ may be in range of approximately 5° to approximately 60°. In the illustrated example, the value of A and A′ is approximately 20°. During use of the atmospheric probe 104a, the reference plane 107 is typically oriented horizontally with respect to a ground plane. In this regard, the illustrated example of atmospheric probe 104a may be particularly suitable for measuring a horizontal wind vector in a range of 360° (as the ports 106a, 106b are evenly distributed about the probe with an angular separation of C) and for measuring a vertical wind vector in a range of approximate ±45° with respect to the reference plane 107. In the illustrated example, each group of ports 106 includes six ports angularly separated by 60°. It will be appreciated that more or fewer ports 106 may be used in each group with their angular separation C adjusted as needed.

A third group of ports 106c may be positioned at the top of the probe. The third group of ports 106c may be used in conjunction with the first and second groups or may be used independently thereof. For example, as will be discussed in further detail below, atmospheric probe 104a may be mounted to an aircraft and the third group of ports 106c may be used for measuring airspeed while the aircraft is in forward flight while the first group of ports 106a and second group of ports 106b may be used for measuring atmospheric wind while the aircraft is hovering. In some embodiments, the third group of ports 106c may not be associated with internal pressure sensors and may instead be associated with one or more other atmospheric sensors within the probe 104, for example, a thermometer or a humidity sensor.

In some examples, the probe 104a may include an integrated location sensor (e.g., GPS) for determining a location of the probe 104a and a transmitter for sending the atmospheric data and location data to a ballistics computer or other atmospheric mapping platform.

FIG. 3A illustrates an example of a pressure contour around a spherical atmospheric probe 104a with a wind direction from left to right in the figure. At the leading side, directly facing the incoming wind, the pressure is elevated at a stagnation point as compared to an ambient baseline of 0. At the trailing side, however, the pressure is reduced below the baseline of 0. Along the opposing sides, the air molecules move more rapidly and spread apart causing a significant decrease in pressure as expected under Bernoulli's principle.

The positioning of the ports 106 and associated pressure sensors 126 about the atmospheric probe 104a allow the atmospheric probe 104a to take advantage of pressuring mapping like that shown in FIG. 3A to determine a wind speed and wind direction. For example, a higher wind speed will cause a greater increase in pressure at the stagnation point and lower pressure along the side regions, allowing a calculation of wind speed based on the degree of pressure increase and pressure decrease relative to ambient pressure or to each other. Additionally, the port measuring the highest pressure can generally be assumed to be nearest the stagnation point. Accordingly, those skilled in the art will understand that atmospheric probe 104a may be empirically programmed and calibrated by subjecting the atmospheric probe 104a to various known magnitudes and directions of wind in a controlled environment, such as a wind tunnel. Pressure maps may be recorded for each known magnitude and direction. As the location of each port and associated pressure sensor on the probe is known, the pressure maps may consist of a pressure reading at each port. During use, the processor may effectively map the current pressure readings from each of the plurality of pressure sensors and identify a recorded pressure map that most closely resembles the current pressure map. The identified pressure map may be referenced to identify the associated wind speed and direction. When the recorded pressure map differs from any of the recorded pressure maps, the processor may interpolate between the closest matching recorded pressure maps.

Alternatively, the recorded pressure maps may be used to construct a wind measurement algorithm to transform the raw readings from the plurality of pressure sensors into a measured wind speed and wind direction.

FIGS. 3B-3D graphically illustrate example pressure measurements using an atmospheric measurement device and determination of a wind speed and wind direction based on the measurements. While the examples are directed to a spherical atmospheric probe, it should be appreciated that the principles are similarly applicable to other probe shapes, including a cylindrical probe. FIG. 3B shows representative pressure readings from a differential pair of pressure sensors arranged to be diametrically opposed on an atmospheric probe. Plot 1 illustrates the differential pressure at a first wind speed (e.g., 1 m/s), plot 2 illustrates the differential pressure at a second wind speed (e.g., 2 m/s) higher than the first, and plot 3 illustrates the differential pressure at an even higher wind speed (e.g., 3 m/s). The yaw along the x-axis indicates the relative orientation of the differential pair of pressure sensors in relative to the wind direction. For example, at yaw=0, one pressure sensor of the pair is oriented directly into the oncoming wind and the other pressure sensor of the pair is oriented directly in the direction the air is moving. As is appreciated by comparing the three plots, the magnitude of the characteristic signal increases in proportion to the dynamic pressure. This may be characterized by:

$$0.5 * air density * {airspeed}^{2} .$$

FIG. 3C shows representative pressure readings from a differential pair of pressure sensors arranged to be diametrically opposed on an atmospheric probe. The six different plots represent different vertical pitches of the atmospheric probe with respect to the wind direction. That is, assuming the wind is travelling horizontally, the plots represent 0°, 10°, 20°, 30°, 40°, and 50° of pitch of the atmospheric probe with respect to horizontal. The yaw along the x-axis indicates the relative orientation of the differential pair of pressure sensors in relative to the wind direction. As is appreciated by comparing the six plots, the magnitude of the characteristic signal is affected by the pitch, or tilt, of the atmospheric probe.

The top graph in FIG. 3D shows representative pressure readings from six pressure sensors arranged equidistantly around an atmospheric probe. Each of the six different plots represents a pressure sensor. The representative pressure readings are idealized in that noise related to sensor bias and/or atmospheric changes has been filtered out. The bottom graph shows the results of a mathematical manipulation of the six plots. In particular, the six pressure sensors are assigned into differential pairs and the sum of each pair is plotted as s1-s3. These plots can be used to determine a wind direction with respect to the atmospheric probe. In particular, the plots s1-s3 can be used to determine the current orientation of the atmospheric probe based on the phasing of these three signal. The three plots sum(p²), sum(dp²), and sum(s²) illustrate mathematical operations applied to the plots s1-s3 that allow the atmospheric measurement device to determine wind speed. Notably, by duplicating these plots based on an additional six pressure sensors on a different hemisphere of the atmospheric probe, the atmospheric measurement device can also determine pitch in relation to the wind direction. In particular, the sum of the pressure measurements of one hemisphere will decrease while the sum of the pressure measurements of the other hemisphere increases.

An atmospheric measurement device 100 may utilize some or all of the principles illustrated in FIGS. 3A-3D to determine a wind direction in two-dimensions or three-dimensions, depending on the configuration of the pressure sensors on the atmospheric probe, relative to the atmospheric probe 104 as well as the wind speed.

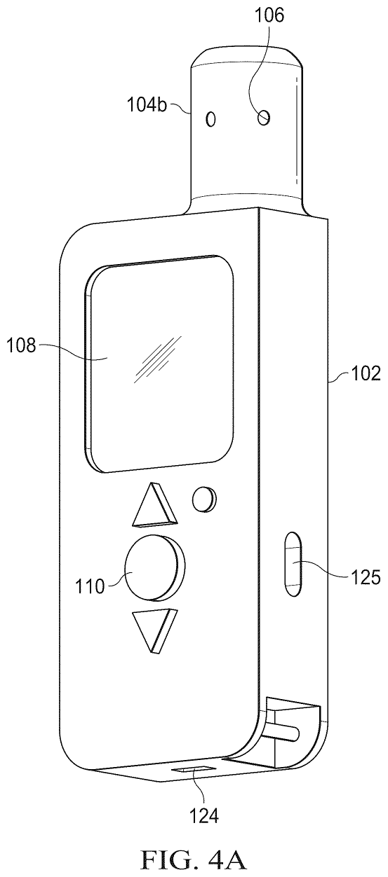

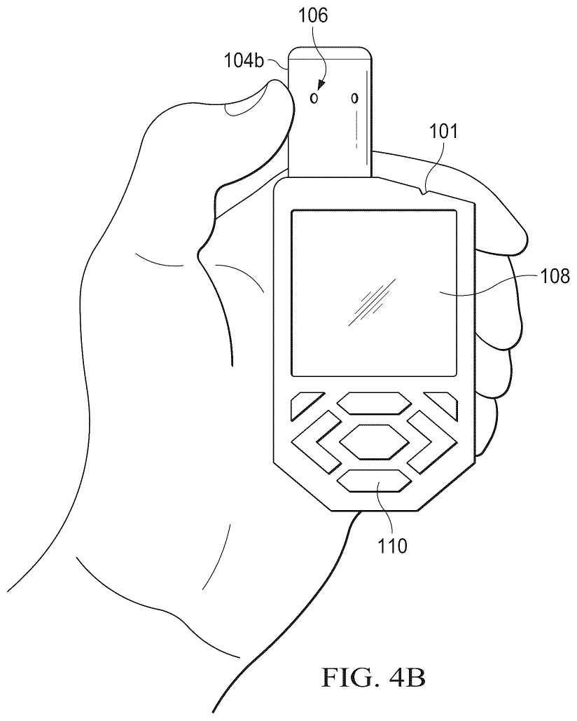

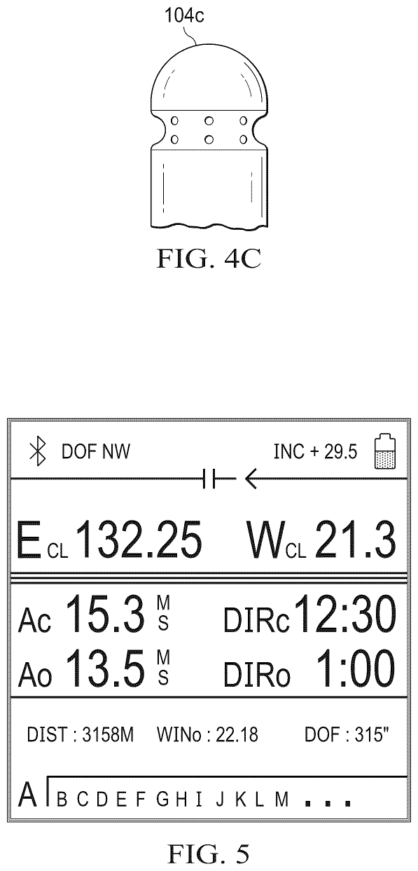

Notably, the atmospheric probe 104a need not be spherical in shape as the wind measurement algorithm may compensate for any known shape to ensure an accurate wind measurement based on the specific shape of the probe. For example, FIG. 4A illustrates another example of a handheld atmospheric measurement device with an atmospheric probe 104b. The atmospheric probe 104b is substantially cylindrical in shape. Although any suitable dimensions may be used, in the illustrated example the diameter of the outer surface of the atmospheric probe 104b is approximately 10-40 mm. Six ports 106 are disposed about a vertical axis of the atmospheric probe 104b, each port 106 associated with a respective pressure sensor. The handheld atmospheric measurement device of FIG. 4A may be substantially similar to the handheld atmospheric measurement device of FIG. 1A. For example, it includes a housing 102 configured to be hand-held by a user, a display 108, a user interface 110, and a mounting interface 124. The atmospheric measurement device of FIG. 4A also includes a charging port 125, which may be a USB-C format interface.

Another example of a handheld atmospheric measurement device is illustrated in FIG. 4B. The handheld atmospheric measurement device of FIG. 4B may be substantially similar to the handheld atmospheric measurement device of FIG. 4A. One difference between the two is that the handheld atmospheric measurement device of FIG. 4B includes an alignment feature 101. In the illustrated example, the alignment feature 101 is a V-shaped notch formed into the housing. A user may utilize the alignment feature 101 to visually orient the atmospheric measurement device in relation to a vector of interest.

FIG. 4C illustrates another example of an atmospheric probe 104c for an atmospheric measurement device. The atmospheric probe 104c has a generally cylindrical shape with an annual concave recess. The ports 106 and associated pressure sensors are positioned within the recess.

The atmospheric probes 104b and 104c of FIGS. 4A-4C may be integrally formed into the housing 102 or may be detachable. For example, a threaded connection may be formed between the atmospheric probe 104 and the housing. In some examples, the atmospheric probes 104b and 104c include only a single row of ports 106 and associated pressure sensors and in some embodiments may include a plurality of rows. When provided with a single row of sensors, an atmospheric probe 104 may determine a horizontal component of wind direction and wind speed but may not determine a vertical component thereof.

FIG. 5 illustrates an example of a graphical user interface (“GUI”) that may be presented on a display 108 of a handheld atmospheric measurement device 100. The example GUI of FIG. 5 is arranged in three vertically arranged panels. The top panel displays in the top row a wireless connection status, a current direction of fire (orientation) relative to compass, an inclination, and a battery status. The top panel displays in a bottom row a calculated elevation and a windage to a target. Between the two rows of the top panel is a visual cue indicating to a user a direction to tilt the device to reach a vertical orientation. In the second panel, the GUI displays current airspeed and current wind direction as well as average airspeed and average wind direction (e.g., over last 20s). In the bottom panel of the GUI, a distance to a target, an average windage correction (e.g., over last 20s), and a direction of fire to the target are provided. A user may selectively access a plurality of stored targets to ascertain the distance, windage, and direction of each target.

The atmospheric measurement device 100 may be wirelessly connected to any suitable device as discussed herein. For example, it may be connected to a laser range finder or to a HUD. In other examples, the atmospheric measurement device may be connected to a mobile device with a data connection to access target data, topographic maps, meteorological information, wind simulation data (e.g., that discussed in relation to FIGS. 3A-3D), etc. Some information provided by the GUI may be determined, at least in part, using a 9DOF, 6DOF, IMU, or other suitable sensor(s) in or in communication with the atmospheric measurement device. For example, the inclination may be determined using such sensor systems. The elevation, windage, distance, average windage, and direction of fire to target information may be determined based upon a three-dimensional location of a currently selected target in relation to a three-dimensional location of the atmospheric measurement device as determined by GPS, laser distance measurement, measured pressures, inclination, etc. The wind direction and wind speed information may be calculated based on pressure measurements provided by the atmospheric probe 104.

Although not shown in FIGS. 4A-4B, a handheld atmospheric measurement device 100 may include a light, for example directed downward from the bottom of the housing. The light may be an infrared or red LED and may be used to illuminate maps or charts in dark environments. In some examples, the LED may be internally positioned within the housing and one or more light guides (e.g., light pipe or fiber optic) may direct light from inside the housing to a port along the bottom, or elsewhere, of the housing.

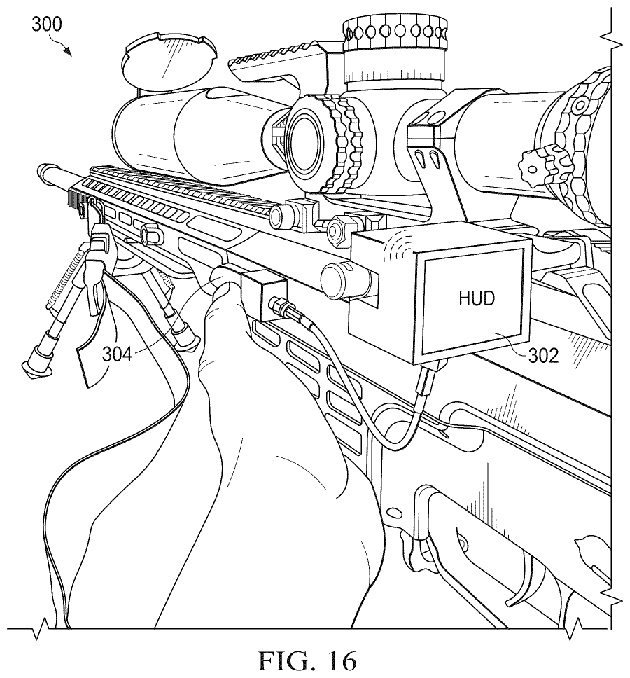

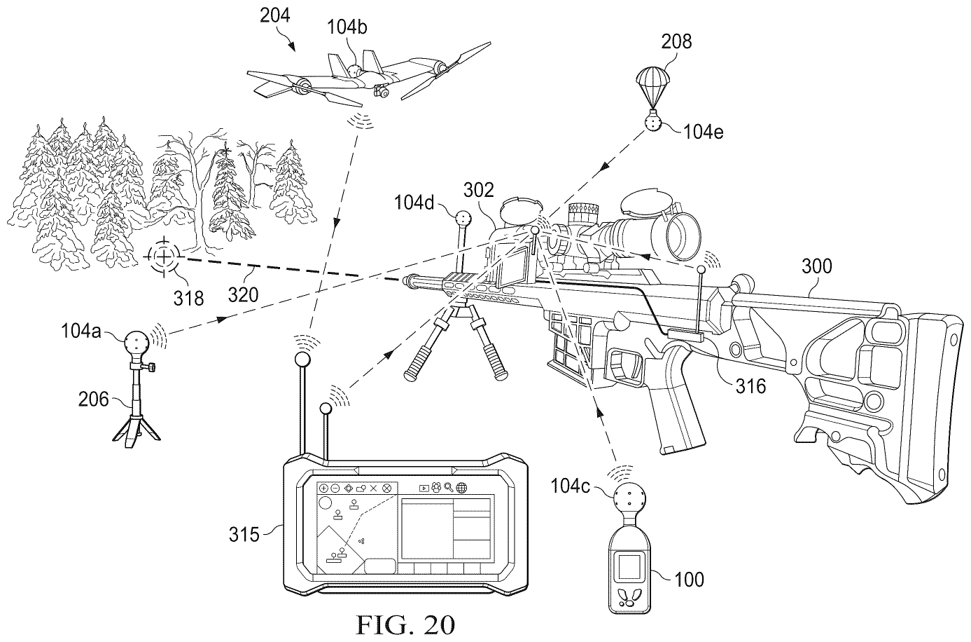

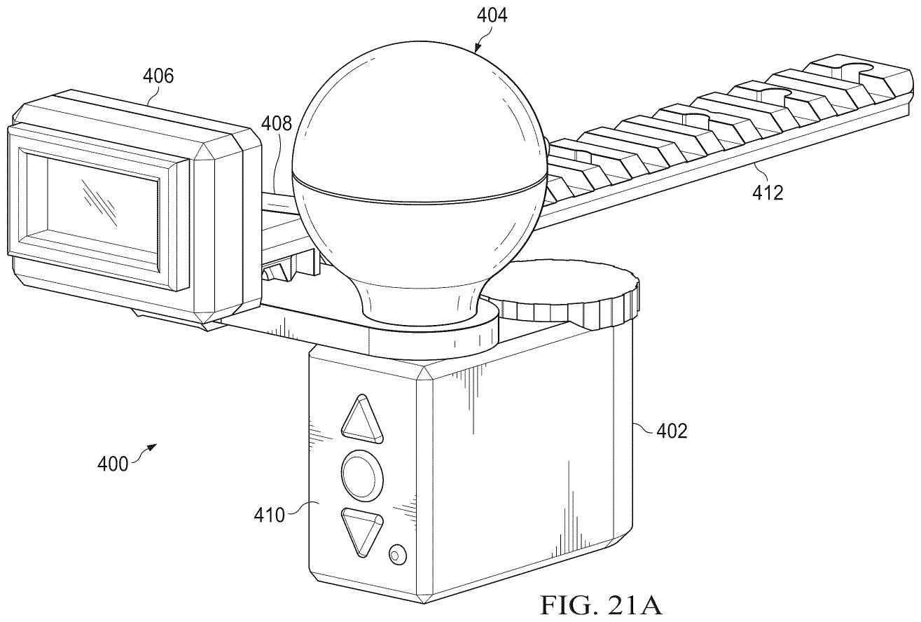

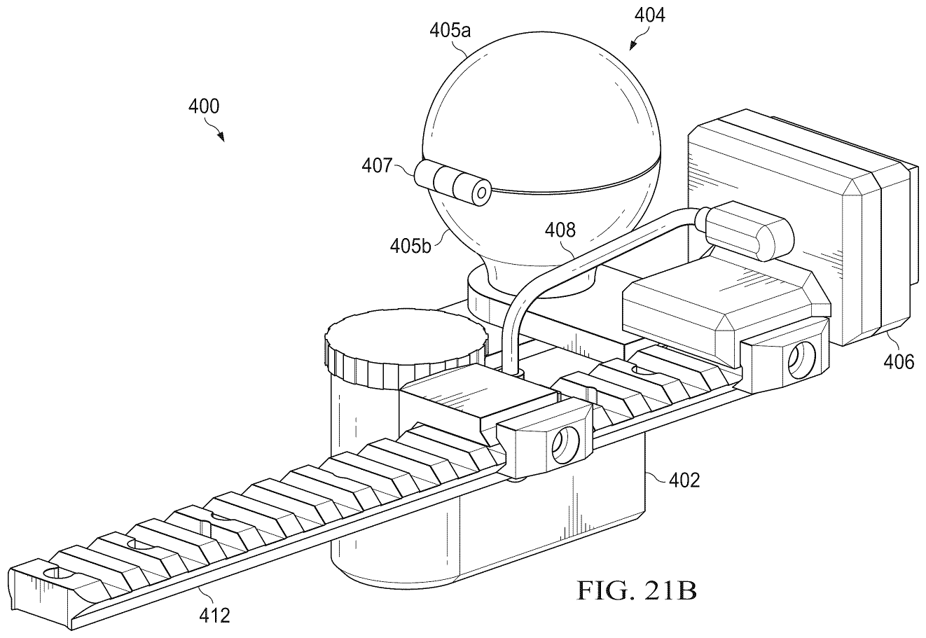

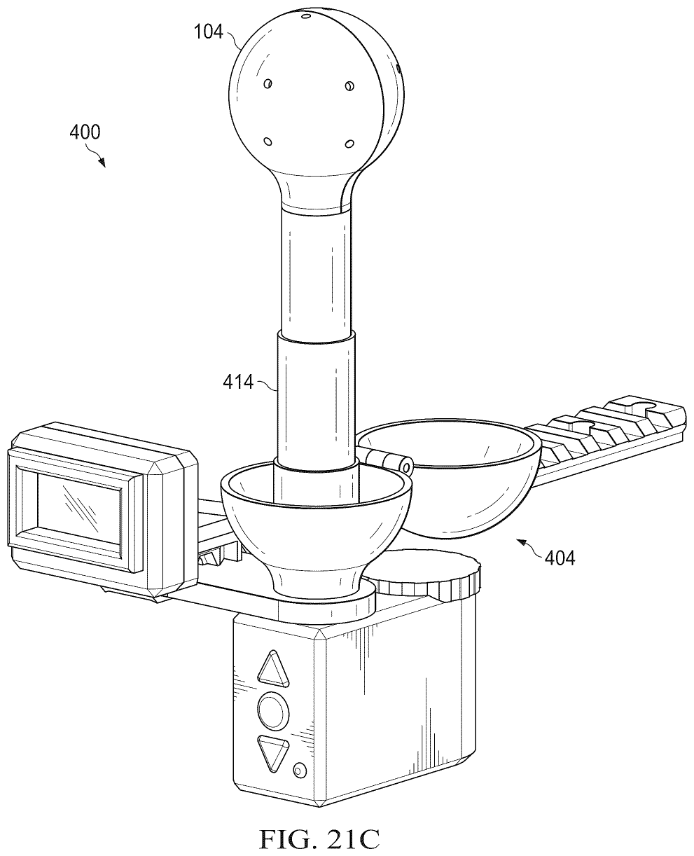

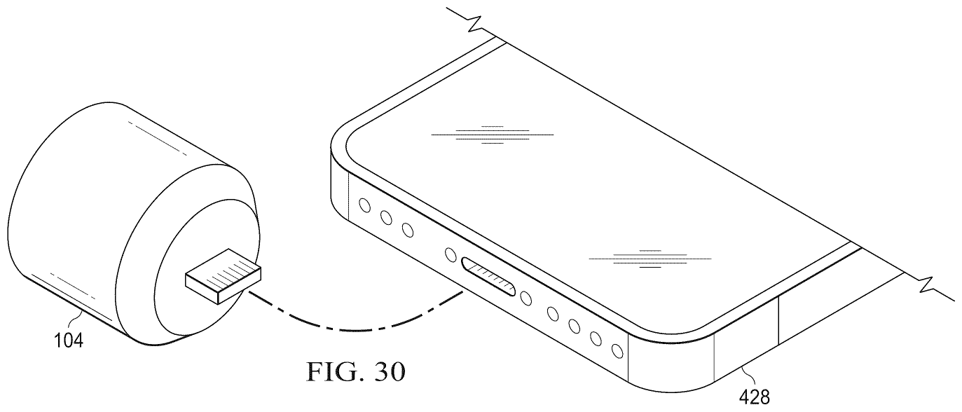

It should be appreciated that the graphical user interface of FIG. 5 may similarly be presented on a HUD 302 (FIG. 16), a UAV controller 315 (FIG. 20), a display device 406 (FIG. 21A), or mobile device 428 (FIG. 30).

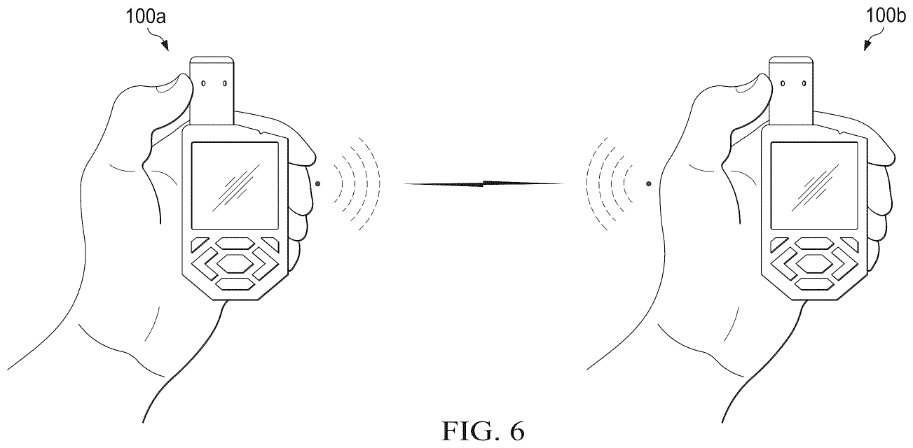

FIG. 6 illustrates communication between a plurality of atmospheric measurement devices 100a and 100b. The devices 100a, 100b may communicate wirelessly via cellular data connection, radio frequency, Bluetooth, or any other suitable wireless communications protocol. In the illustrated embodiment, the atmospheric measurement devices 100a, 100b are hand-held devices, but it should be appreciated that the concepts discussed in relation to the devices 100a, 100b are similarly applicable to other atmospheric measurement devices described herein. In some examples, the devices 100a, 100b include a walkie-talkie function in which a user may depress a button to activate audio communication. In some examples, the devices 100a, 100b may communicate data such as atmospheric measurement data (e.g., wind direction and wind speed) and/or target data.

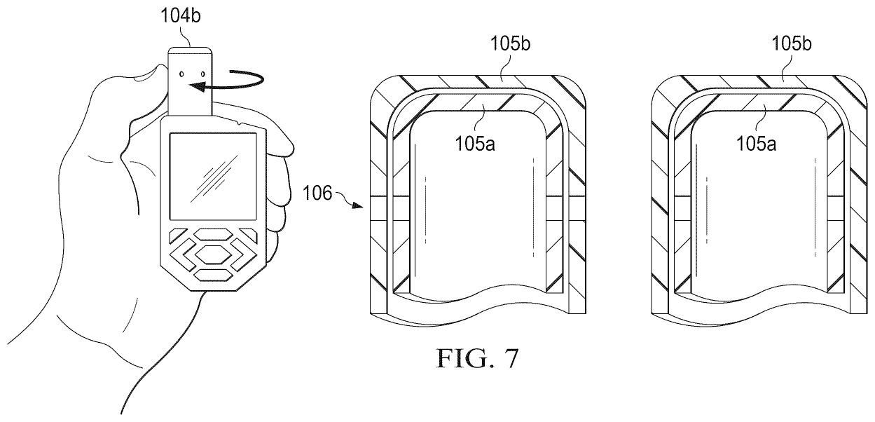

FIG. 7 illustrates an example of a cover for an atmospheric probe 104b. The cover may comprise an outer shell 105b that is configured to envelop an inner shell 105a. The ports 106 may extend through both the inner shell 105a and outer shell 105b. By rotating the outer shell 105b, a user may effectively block the ports 106 when the atmospheric probe 104b is not in use. This may help protect the pressure sensors from moisture and debris. Additionally, the outer shell 105b may effectively seal off the pressure sensors to facilitate calibration. While the inner shell 105a may be integral part of the atmospheric probe 104b, the outer shell 105b may be removable or may also be integral to the probe 104b. Guide tracks, protrusions, and/or recesses may be formed into one or both of the inner shell 105a and outer shell 105b to provide haptic feedback when the portion of the ports 106 in the outer shell 105b is properly aligned with the portion of the ports 106 in the inner shell 105a and/or when the portions of the ports are misaligned to retain the cover in a locked closed position.

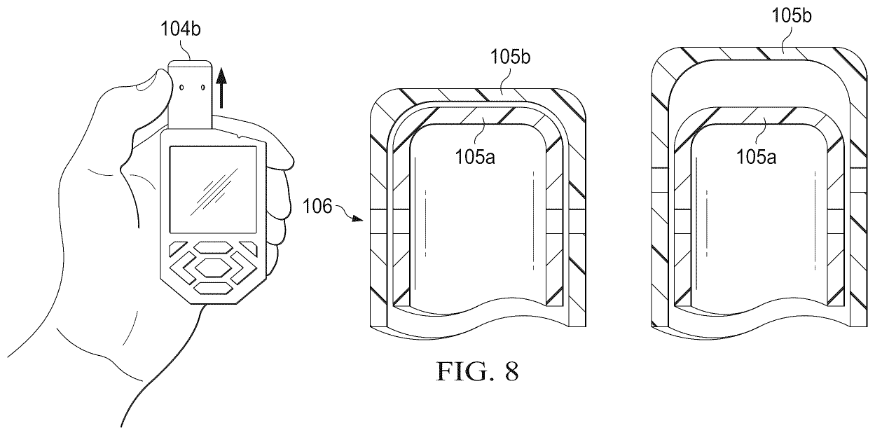

FIG. 8 illustrates another example of a cover for an atmospheric probe 104b. In this example, by vertically translating the outer shell 105b, a user may effectively block the ports 106 when the atmospheric probe 104b is not in use. Although illustrated as an example in which outer shell 105b blocks the pressure sensors when extended upward in relation to the inner shell 104a, it should be appreciated the ports may be configured such that the shell 105b blocks the pressure sensors when retracted downward.

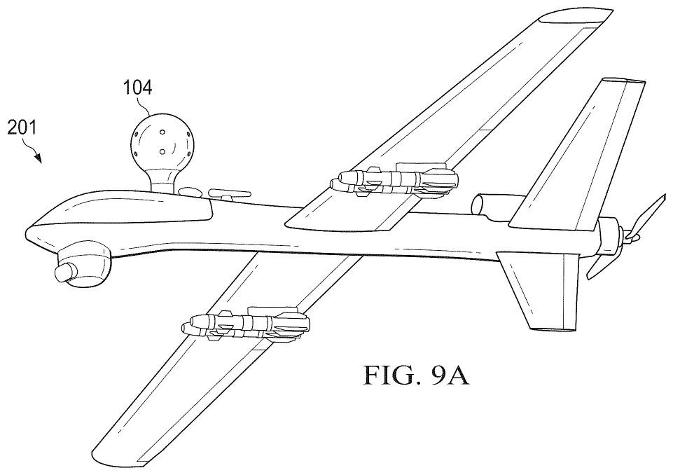

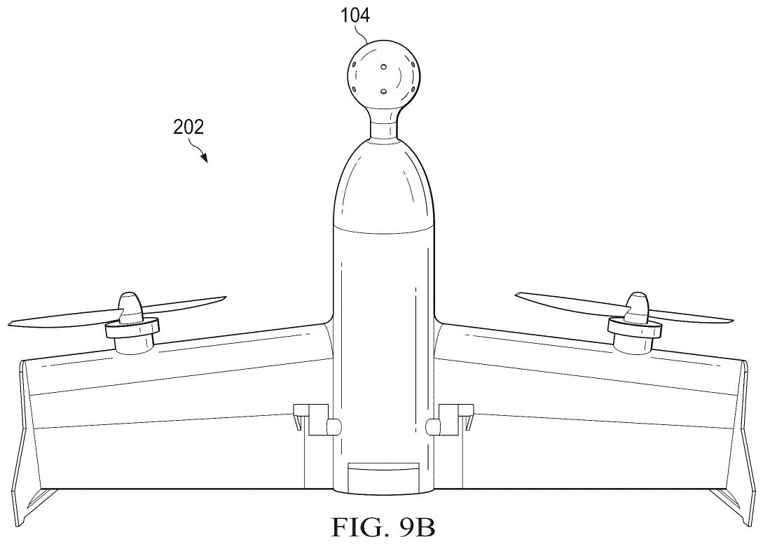

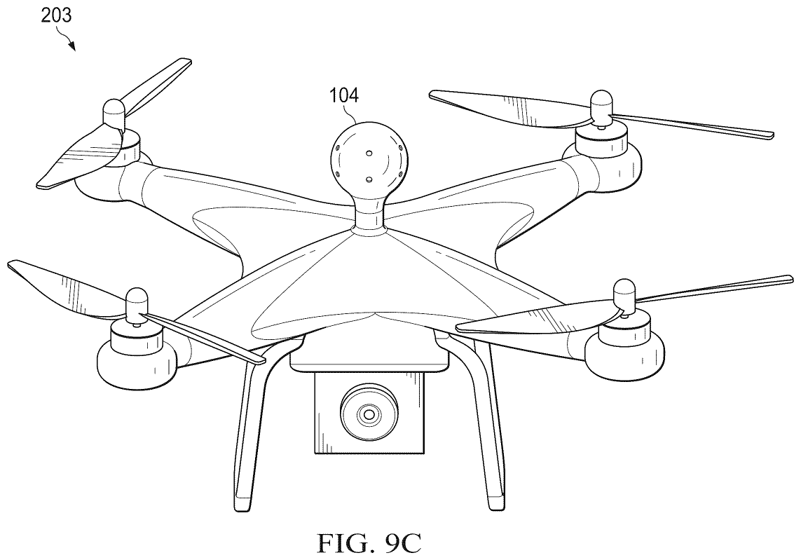

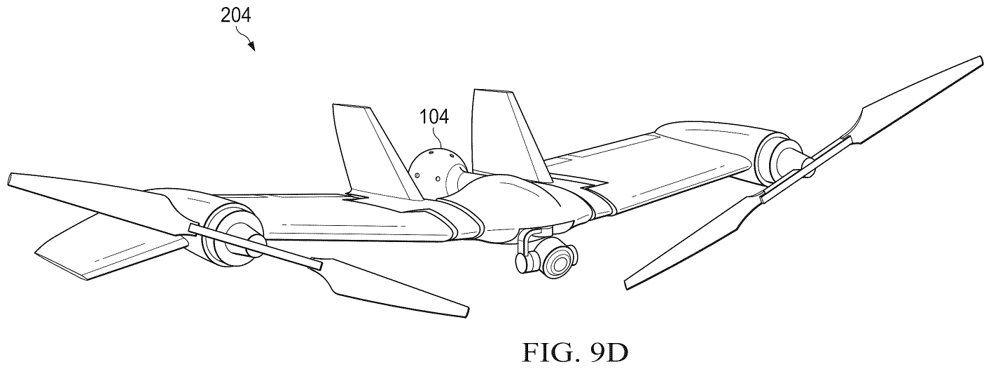

The atmospheric probes 104 are not limited to use in a handheld atmospheric measurement device as discussed above. Rather, the atmospheric probes 104 are contemplated for use in a variety of applications as discussed further below. It should be appreciated that reference to an atmospheric probe 104 herein may optionally include an atmospheric probe similar in design to any of atmospheric probes 104a-104c. FIGS. 9A-9D illustrate examples of unmanned aerial vehicles incorporating an atmospheric probe 104.

FIG. 9A illustrates a large-scale unmanned aerial vehicle (“UAV”) 201 capable of autonomous or remote-controlled flight for military applications, such as an MQ-9 Reaper. An atmospheric probe 104 is mounted atop the fuselage for collection of atmospheric wind speed and wind direction during flight. A processor, such as a processor incorporated into the atmospheric probe 104 or a processor of a flight computer incorporated into the UAV 201, may receive signals from the plurality of pressure sensors of the atmospheric probe 104. The processor may also receive flight metrics including, for example, airspeed or ground speed of the UAV 201 (as may be measured by Global Positioning Satellite receivers of the UAV, for example), thrust settings, etc. In this regard, the measured wind speed and wind direction from the atmospheric probe 104 will not accurately reflect atmospheric wind speed and wind direction. More specifically, forward flight of the UAV 201 will affect the pressure readings of the atmospheric probe 104. However, the processor may be configured to utilize the flight metrics to account for relative wind speed and direction caused by forward flight of the aircraft and subtract these values from the measured wind speed and direction to estimate the actual atmospheric wind speed and direction. It should be appreciated that although illustrated as being mounted atop a forward portion of the fuselage of the UAV 201, the atmospheric probe 104 may be mounted at any suitable location and in any suitable orientation.

FIG. 9B illustrates a small-scale UAV 202 of a tail-sitter configuration. An atmospheric probe 104 is mounted at the nose of the fuselage for collection of atmospheric wind speed and wind direction during flight. A processor, such as a processor incorporated into the atmospheric probe 104 or a processor of a flight computer incorporated into the UAV 202, may receive signals from the plurality of pressure sensors of the atmospheric probe 104. As the UAV 202 is capable of forward flight, the processor may also receive flight metrics to account for relative wind speed and direction caused by forward flight of the UAV. The UAV 202 is also capable of hovering. As such, the atmospheric probe 104 may be oriented on the nose as shown in FIG. 9B to optimize data collection during hovering with minimal disturbance caused by either forward flight or prop wash. It should be appreciated that although illustrated as being mounted at the nose of the UAV 202, the atmospheric probe 104 may be mounted at any suitable location and in any suitable orientation.

FIG. 9C illustrates a small-scale UAV 203 of a quadcopter configuration. An atmospheric probe 104 is mounted at a central location atop the body or fuselage for collection of atmospheric wind speed and wind direction during flight. A processor, such as a processor incorporated into the atmospheric probe 104 or a processor of a flight computer incorporated into the UAV 203, may receive signals from the plurality of pressure sensors of the atmospheric probe 104. As the UAV 203 is capable of lateral flight, the processor may also receive flight metrics to account for relative wind speed and direction caused by forward flight of the UAV. Typically, the UAV 203 would be expected to collect data while hovering. As such, the atmospheric probe 104 may be oriented atop the body as shown in FIG. 9C to optimize data collection during hovering with minimal disturbance caused by either forward flight or prop wash. It should be appreciated that although illustrated as being mounted atop the body of the UAV 203, the atmospheric probe 104 may be mounted at any suitable location and in any suitable orientation.

FIG. 9D illustrates another small-scale UAV 204 of a tail-sitter configuration. An atmospheric probe 104 is mounted in a cargo bay area of the fuselage for collection of atmospheric wind speed and wind direction during flight. A processor, such as a processor incorporated into the atmospheric probe 104 or a processor of a flight computer incorporated into the UAV 204, may receive signals from the plurality of pressure sensors of the atmospheric probe 104. As the UAV 204 is capable of forward flight, the processor may also receive flight metrics to account for relative wind speed and direction caused by forward flight of the UAV. The UAV 204 is also capable of hovering. As such, the atmospheric probe 104 may be oriented within the cargo bay as shown in FIG. 9D to optimize data collection during hovering with minimal disturbance caused by either forward flight or prop wash. It should be appreciated that although illustrated as being mounted in the cargo bay of the UAV 204, the atmospheric probe 104 may be mounted at any suitable location and in any suitable orientation. Further, the atmospheric probe 104 may be configured to rotate out of the cargo bay. See, for example, U.S. Pat. No. 11,542,002, entitled “UNMANNED AERIAL VEHICLE AND CONTROL SYSTEMS AND METHODS,” which is incorporated by reference herein in its entirety.

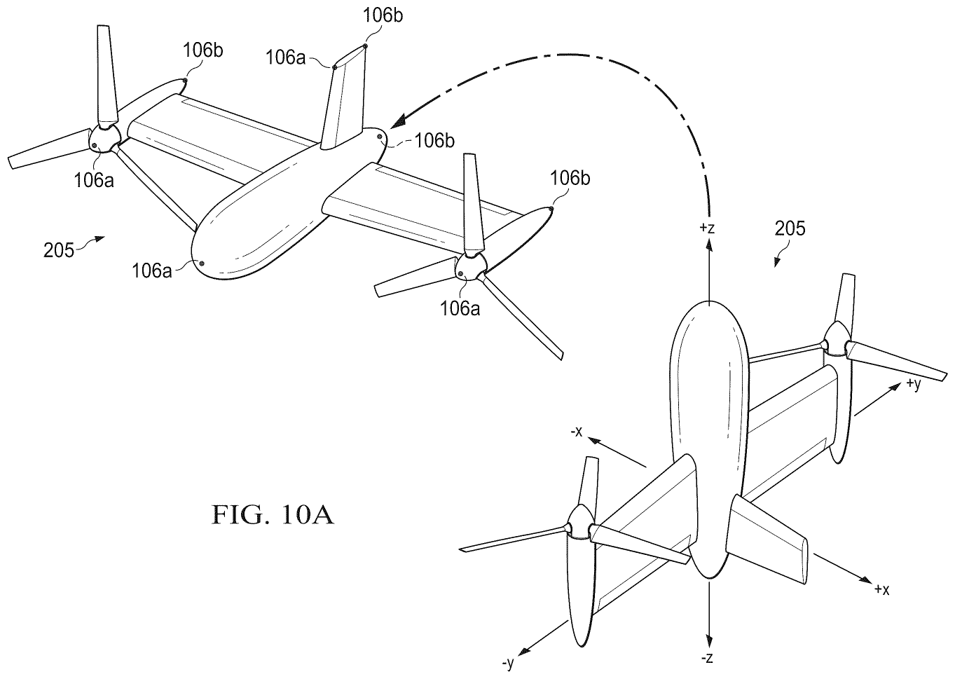

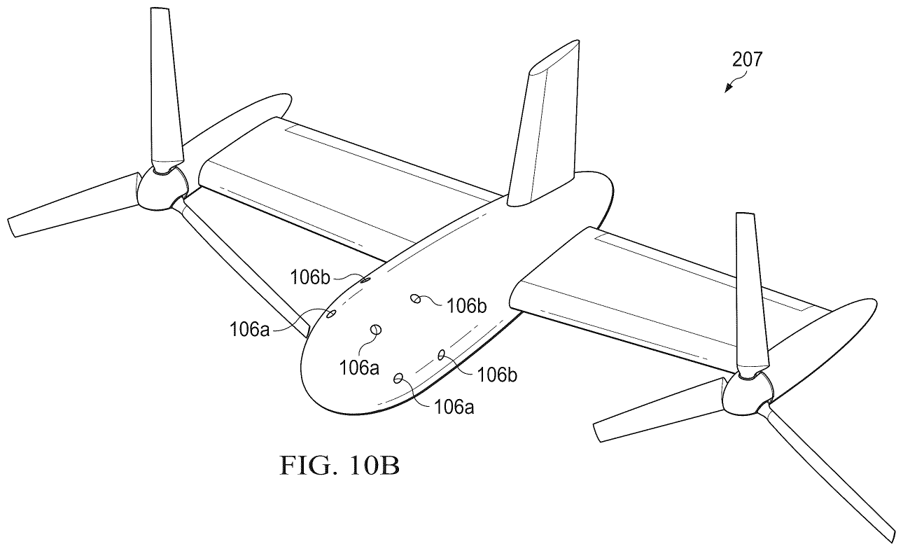

FIGS. 10A-10B illustrate examples of unmanned aerial vehicles with integrated ports and associated pressure sensors in accordance with an embodiment of the present disclosure. The UAV 205 of FIG. 10A is a tail-sitter aircraft configured to transition from vertical flight to forward flight and is capable of hovering. The UAV 205 includes a fuselage with a port 106a at its nose and a port 106b at its tail, a vertical stabilizer with a port 106a at its leading edge and a port 106b at its trailing edge, and opposing rotor assemblies (e.g., motor, motor housing, rotor, and rotor hub) each with a port 106a at their front and a port 106b at their rear. The ports 106a may form a first group and the ports 106b may form a second group, similar to the manner discussed in relation to FIG. 2A. Typically, during forward flight, the first group of ports 106a would be expected to experience greater pressures than the second group of ports 106b. Although configured to each obtain absolute pressure values, the pressure differential between the first group of ports 106a and the second group of ports 106b may be used to calculate an airspeed. Further, the UAV 205 is capable of measuring wind speed and direction during any phase of flight whether hovering, flying forward, or during a transition in between or when landed on the ground. Although the ports of UAV 205 are distributed across uneven and non-spherical surfaces, the principles discussed above in relation to pressure mapping and calculating a wind speed and wind direction are similarly applicable to the UAV 205.

The UAV 207 of FIG. 10A is a tail-sitter aircraft configured to transition from vertical flight to forward flight and is capable of hovering. The UAV 207 includes a fuselage with a first group of ports 106a distributed circumferentially about the fuselage near its nose and a second group of ports 106b distributed circumferentially about the fuselage rearward of the first group. The ports 106a may form a first group and the ports 106b may form a second group, similar to the manner discussed in relation to FIG. 2A. Although the ports of UAV 207 are distributed across uneven and non-spherical surfaces, the principles discussed above in relation to pressure mapping and calculating a wind speed and wind direction are similarly applicable to the UAV 207.

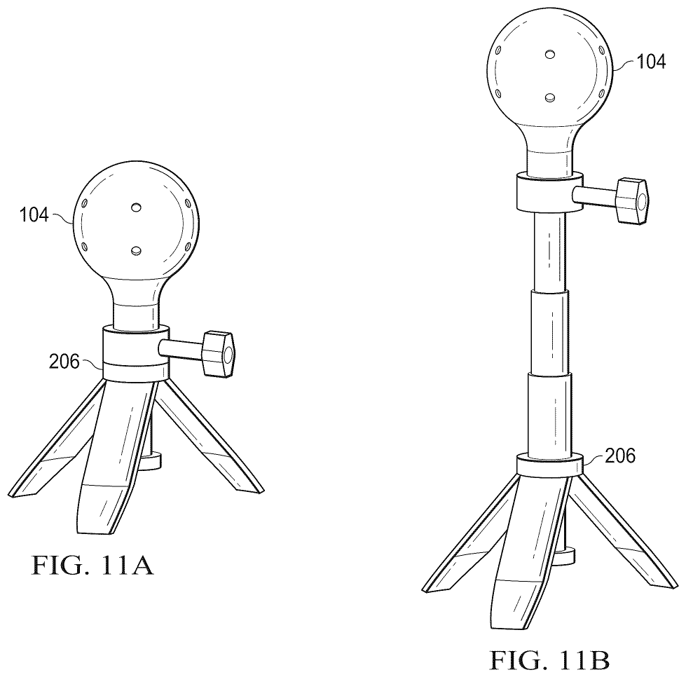

FIGS. 11A-11B illustrate an example of an atmospheric probe incorporated into a stationary field deployable node in accordance with an embodiment of the present disclosure. The term “node” as used herein may refer to a discrete atmospheric sensing unit configured to be used individually or as a node of a larger sensing swarm or array of nodes. Further, UAVs with atmospheric probes or integrated atmospheric sensors may also be considered a node in a swarm or array for mapping a larger area or volume of wind speed, direction, and other atmospheric conditions. FIG. 11A shows a node comprising an atmospheric probe 104 and a telescoping tripod 206 in a stored configuration. FIG. 11B shows the tripod 206 in an extended configuration. As will be appreciated, vegetation, rocks, boulders, and the ground itself may cause disturbances in wind speed and direction such that measurement of the wind at or near ground level may not accurately reflect atmospheric conditions. Accordingly, the tripod 206 may effectively elevate the atmospheric probe 104 to alleviate such disturbances during wind calculations.

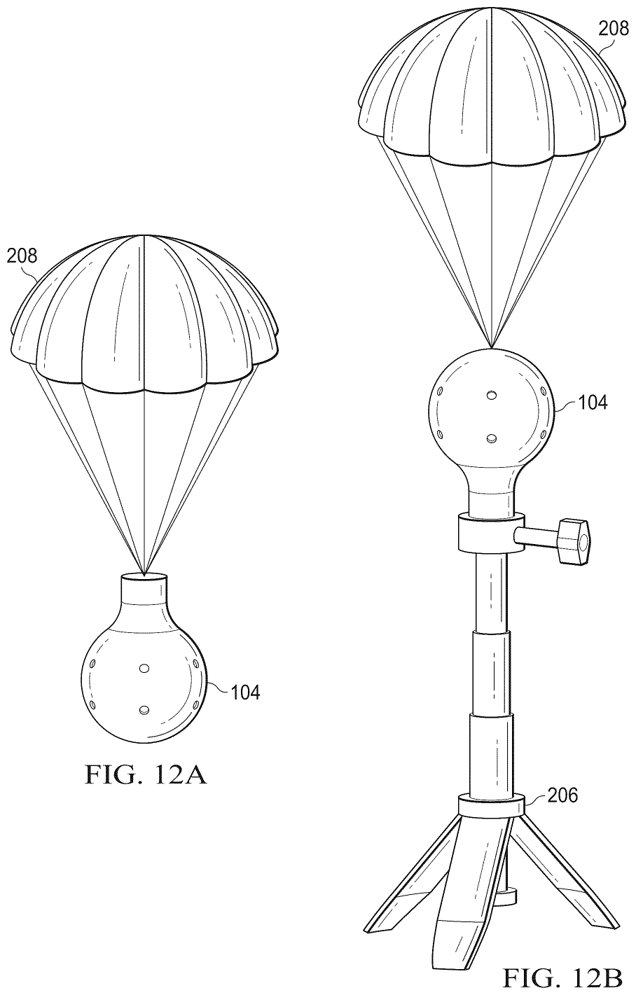

FIGS. 12A-12B illustrate an example of an atmospheric probe incorporated into airborne nodes that may be aerially deployable. In FIG. 12A, an atmospheric probe 104 is secured at its base to a parachute 208. The node may be dropped from a UAV, airplane, or other aircraft or may be launched to a deployment altitude as a projectile. For example, an explosive charge may be used to propel the atmospheric probe 104 and parachute 208, in a stored configuration, from a mortar tube or similar platform. At altitude, the parachute 208 may be deployed. An advantage of the embodiment of FIG. 12A is that the atmospheric probe 104 and parachute 208 alone may be relatively inexpensive and can be deployed in large quantities without a need to recover each probe 104 after use. This arrangement also provides for collecting atmospheric data over a substantial range of altitudes. However, once the atmospheric probe 104 reaches ground level, it may easily become obstructed and unreliable. As shown in FIG. 12B, an atmospheric probe 104 may be attached to a tripod 206 (similar to FIG. 11A) and to a parachute 208. In this regard, the atmospheric probe 104 of FIG. 12B may be deployed at a high altitude in a manner similar to that discussed in relation to FIG. 12A but upon reaching the ground may be maintained at a useful elevation by the tripod 206. Alternatively, the atmospheric probe 104 may be secured to a stake with a ground penetrating tip with or without a parachute. In some examples, the stake may be tripod 206 with the legs collapsed into a pointed configuration. Upon reaching ground level, the tip of the stake may be driven into the ground by its momentum with a shaft of the stake remaining above ground to support the atmospheric probe 104.

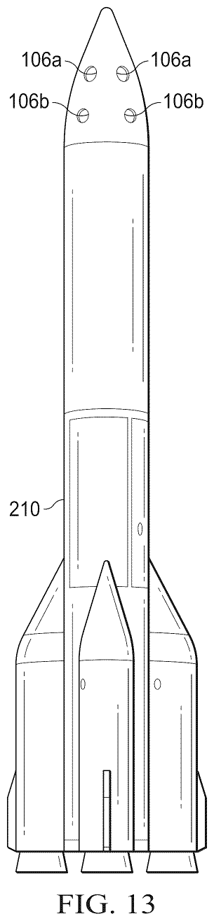

FIG. 13 illustrates an example of a rocket 210 with integrated sensing ports 106a, 106b. The rocket 210 may be a small-scale rocket similar to hobby rockets with a length of 6-24″ or even several meters. The ports 106 and associated pressure sensors within the rocket 210 may be used to measure wind speed and direction in a similar manner to the embodiments discussed above. With sufficient sensitivity, the integrated pressure sensors may be able to calculate atmospheric wind speed and direction during propelled flight. However, given the speed of travel of a rocket, performing such calculations with a high degree of accuracy may be difficult. In some examples, the rocket 210 may be secured to an anchor by a tether. In this regard, the rocket 210 may serve to rapidly deploy the pressure sensors to a high elevation (e.g., 20′ to several hundred feet) and may effectively hover upon reaching the limits of the tether with the anchor remaining on the ground. Accordingly, the rocket 210 may collect wind speed and wind direction while hovering and not being subjected to the high wind speeds of normal rocket flight. An advantage of this embodiment is that rockets may be relatively inexpensive to manufacture as compared to UAVs or other aircraft but can nonetheless collect atmospheric data at an appreciable altitude.

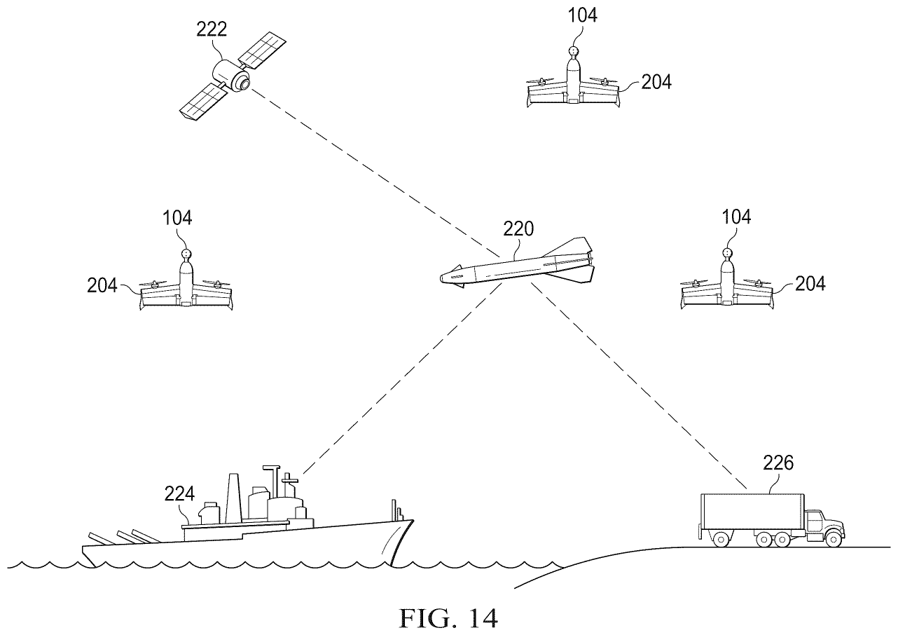

FIG. 14 illustrates an example of a targeting system including a swarm of unmanned aerial vehicles incorporating atmospheric probes in accordance with an embodiment of the present disclosure. Military applications exist for targeting and destroying enemy projectiles such as a missile 220, which may be an intercontinental ballistic missile. Solutions for destroying such missiles include satellite-based 222, sea-based 224, land-based 226, or aircraft-based countermeasures such as launching a projectile to intercept the missile 220 or focusing lasers or other directed-energy weapons onto the missile 220. However, these countermeasures are susceptible to targeting errors caused by unknown atmospheric conditions, including wind. As such, it is contemplated that accurate atmospheric data collection can be used to more accurately target missiles or other threats. As shown in FIG. 14, a swarm of UAVs 204 with mounted or integrated atmospheric probes 104 may be deployed throughout a volume of airspace along the trajectory of the missile 220. Although only a few UAVs 204 are illustrated, it is contemplated that a swarm of dozens or hundreds of UAVs could be deployed to: 1) accurately assess the atmospheric conditions for improving countermeasure targeting; and 2) to potentially act as a countermeasure themselves but confusing the missile's targeting system and/or colliding with the missile to destroy it. It will be appreciated that other atmospheric probe embodiments discussed herein may be used in or as a swarm as discussed in relation to FIG. 14, such as the parachute-mounted embodiment of FIG. 12A.

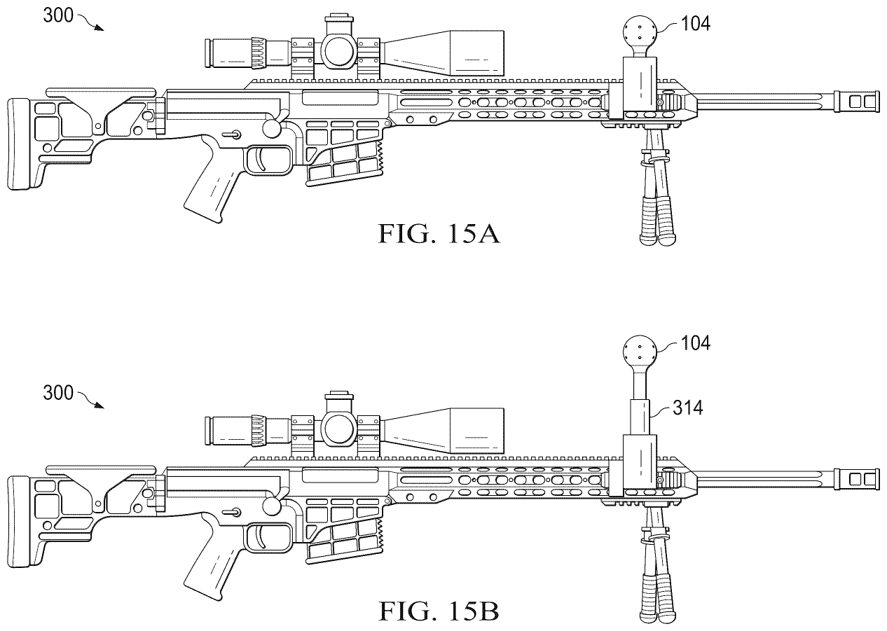

FIGS. 15A-15B illustrate an example of a weapon-mounted atmospheric probe which may be used to collect atmospheric data to refine a ballistic solution for a projectile. As shown in FIG. 15A, atmospheric probe 104 is mounted to a firearm 300. For example, the atmospheric probe 104 may include an integrated rail mount for securing the atmospheric probe 104 to a picatinny rail or other accessory rail of the firearm 300. The atmospheric probe 104 of FIG. 15A may include an integrated processor and display for providing wind measurements directly to an operator or may transmit raw pressure data or calculated wind measurements to a ballistics computer. FIG. 15B illustrates a similar arrangement to that shown in FIG. 15A but with the addition of a telescoping mast 314 between the rail mount and the atmospheric probe 104. The elevated positioning provided by the telescoping mast 314 may help remove the atmospheric probe 104 from any wind disturbances created by the firearm 300 and may also remove the atmospheric probe 104 from the line of sight of the scope, depending on the size of the atmospheric probe 104 and the offset of the mounting position. Additionally, in some examples, the atmospheric probe 104 may include an integrated compass and the telescoping shaft may aid in distancing the compass from the metal components of the firearm 300 that may alter readings. The atmospheric probes 104 of FIGS. 15A-15B may be detachable from the firearm 300 and deployed at a remote location.

FIG. 16 illustrates the firearm 300 with a heads-up display (“HUD”) 302. The atmospheric probe 104 (obstructed from view in FIG. 16) may transmit pressure data or calculated wind measurements to the HUD 302, either wirelessly or by wire, for display to the operator. In some examples, the HUD 302 may receive the data from the atmospheric probe 104 and use it in calculating a ballistic solution incorporating elevation and windage adjustments needed to compensate for the wind. A controller 304 in operative communication with the HUD 302 may provide an operator interface for control of the HUD 302.

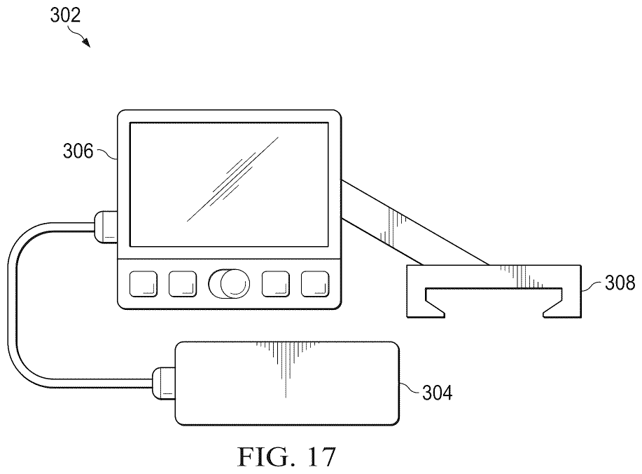

FIG. 17 illustrates an example of HUD 302 which includes controller 304, display 306, and a rail mount 308 for securing the HUD 302 to the firearm 300. The HUD 302 may include a processor, a memory, and a receiver. The receiver may be configured to receive data from a variety of sensors, including from the atmospheric probe 104 or other weapon-mounted sensors. The display 306 may be configured to show one or more of current wind measurements, a ballistic firing solution based on the wind measurements, sensor data (e.g., direction of fire, slant angle, weapon tilt, target range), etc.

Additional information about utilizing atmospheric data for calculating a ballistic solution and about weapon-mounted HUD may be found in U.S. Pat. No. 11,619,470, entitled “SYSTEMS AND METHODS OF CALCULATING A BALLISTIC SOLUTION FOR A PROJECTILE,” and U.S. Pat. App. Pub. No. 2022/0412692, entitled “WEAPON MOUNTABLE TACTICAL HEADS-UP DISPLAY SYSTEMS AND METHODS,” both of which are incorporated by reference herein in their entirety.

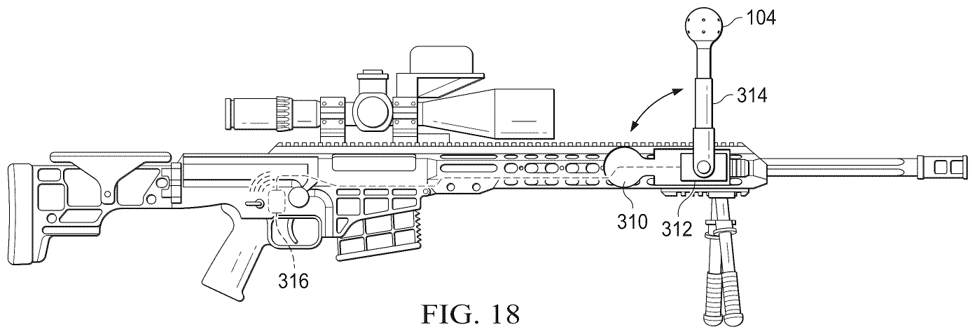

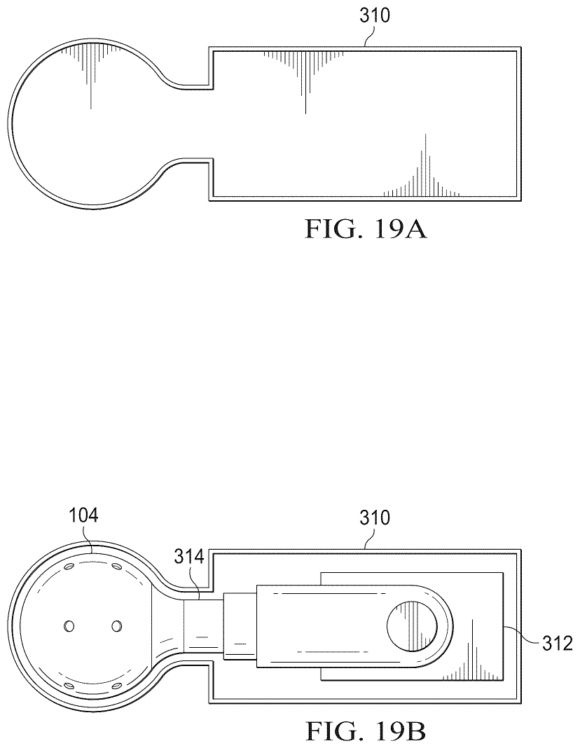

FIGS. 18-19 illustrate another example of a weapon-mounted atmospheric probe. The atmospheric probe 104 is mounted on a telescoping mast 314. The mast 314, in turn, is secured to a base 312. A rail adapter 310 is secured to the accessory rail of the firearm 300. The rail adapter 310 may be configured to remain attached to the firearm 300 whereas the base 312 with the atmospheric probe 104 can be detached from the rail adapter 310 by a quick-release mechanism. A tripod or other support structure may include a corresponding quick-release mechanism for quickly transferring the atmospheric probe 104 between the firearm 300 and other support structures. A pivot connection may secure the mast 314 to the base 312 such that the mast 314 can be swiveled 90° from a stowed configuration to a deployed configuration. Swiveling of the mast 314 may be manual or an actuator may be housed in the base 312 to swivel the mast and/or extend the mast. A remote 316 may be positioned near the trigger-guard for ease of access by a user to activate the atmospheric probe 104 and/or the actuator. As discussed above in relation to FIGS. 15A-17, the atmospheric probe 104 may transmit data to an HUD. The transmission range may be approximately 100 feet or more, allowing wireless communication between the atmospheric probe 104 and HUD while the atmospheric probe 104 is mounted to the rail adapter 310 or when remotely deployed away from the firearm 300.

The rail adapter 310 may act as a heat shield, protecting the atmospheric probe 104 from extreme temperatures of the barrel and/or hand guard when in the stowed configuration. The rail adapter 310 may include an integrated calibration chamber for calibrating the pressure sensors of the atmospheric probe 104 and may provide a protective cover for the probe.

FIG. 20 illustrates an example of a ballistic calculation system utilizing various deployable atmospheric probes in accordance with an embodiment of the present disclosure. In the illustrated example, various nodes are positioned along or around a projectile trajectory 320 between a firearm 300 and a target 318. An atmospheric probe 104a is mounted to a tripod 206, an atmospheric probe 104b is mounted to an airborne UAV 204, an atmospheric probe 104c is mounted to a handheld atmospheric measurement device 100, an atmospheric probe 104d is mounted to firearm 300, and an atmospheric probe 104e is mounted to a parachute 208. It should be appreciated that any number of these types of nodes and others may deployed about the area of operation, and particularly along a corridor of the trajectory 320, to collect atmospheric data and calculate an atmospheric profile along and around the trajectory 320. Each node may transmit atmospheric data directly to a ballistics computer (in HUD 302 or the data may be relayed by an intermediary such as the UAV controller 315. In some examples, the UAV controller 315 may include a ballistics computer and the various nodes may transmit data to the UAV controller 315 which may calculate a ballistic solution and transmit the solution to the HUD 302. The collection of atmospheric data and position data for each node may be used to calculate the ballistic solution for the trajectory 320 in a manner that compensates for the wind and other atmospheric conditions. In some examples, the ballistics computer may create an atmospheric map and interpolate data between the positions of the various nodes. The ballistics computer may assign a weight value to each node based on its position relative to the trajectory 320. For example, atmospheric probe 104e may drift away from the trajectory and thereby provide less valuable atmospheric data whereas the atmospheric probe 104d is positioned nearly in-line with the trajectory 320 and may provide more valuable data.

FIGS. 21A-21C illustrate an example of an atmospheric probe module in accordance with an embodiment of the present disclosure. An atmospheric probe module 400 includes an atmospheric probe 104 and a cover 404. In the illustrated embodiment, the cover 404 includes an upper shell 405a and a lower shell 405b connected by a hinge 407, each of which may be formed from any suitable material including, but not limited to, one or more of a plastic, a polymer, or a metal (e.g., steel, aluminum, or an alloy). A locking mechanism (not shown) such as a latch may be provided to secure the upper and lower shells 405 in the closed configuration. A spring may bias the upper shell 405a toward an open configuration such that releasing the locking mechanism causes the cover to automatically open.

The cover 404 may provide a protective barrier for the atmospheric probe 104, preventing ingress of dirt, water, and/or other debris that may affect the efficacy of the probe. Additionally, the cover 404 may be configured to provide a controlled internal environment for calibration of the atmospheric probe 104. For example, when the cover 404 is closed around the atmospheric probe 104, a seal may be formed to prevent wind from reaching the pressure sensors of the probe. In this regard, a controlled zero-wind environment inside the cover 404 may allow for field calibration of the atmospheric probe 104 without interference from atmospheric conditions. It should be appreciated that the cover 404 may also be integrated or used with any embodiment of an atmospheric probe 104 disclosed herein, including the atmospheric measurement device 100, the UAVs 201-204, the field deployable sensor unit of FIGS. 11A-11B, the aerial deployable sensor unit of FIGS. 12A-12B, or a weapon-mounted atmospheric probe as in FIGS. 15A-19B.

Within the cover 404, the atmospheric probe 104 is mounted to a telescoping mast 414. Similar to the telescoping mast 314, the mast 414 may be manually extended and retracted or may include an actuator to automatically extend and retract the mast.

In the illustrated embodiment, the atmospheric probe module 400 includes a control unit 402. The control unit 402 may include a housing containing one or more processors, memory devices, batteries, and auxiliary sensors such as a humidity sensor. An actuator for manipulating the telescoping mast 414 may also be contained within the housing of the control unit 402. A user interface 410 is integrated with the control unit 402 and may include buttons for instructing the control unit 402 to extend or retract the mast 414, to initiate a calibration procedure, and/or to open the cover 404. In some examples, the control unit 402 may be a ballistics computer configured to calculate firing solutions for target engagement or may in operative communication with a ballistics computer and configured to transmit atmospheric data thereto.

In some embodiments, the control unit 402 includes a 9DOF sensor and a location sensor operable to define a location and/or orientation. For example, 9DOF sensor may define X, Y, and Z components of a vector defining the position and orientation of the control unit. The location sensor may define a location of the control unit in relative space, such as GPS latitude/longitude. The 9DOF sensor may include an IMU that includes a gyroscope, an accelerometer, and/or a magnetometer allowing the 9DOF sensor to capture nine distinct types of motion or orientation-related data: 3 degrees each of acceleration, magnetic orientation, and angular velocity. In some embodiments, the control unit 402 includes a 6DOF sensor operable to define a location and/or orientation. For example, 6 DOF sensor may define X, Y, and Z components of a vector defining the position and orientation of the control unit. In some embodiments, the control unit 402 includes a compass configured to determine a magnetic orientation. Additional information about sensors that may be integrated into the control unit may be found in U.S. Pat. App. Pub. No. 2022/0412692.

In some embodiments, the control unit 402 includes an artificial intelligence or machine learning module which may implemented in hardware and/or software such as the one or more processors and memory devices of the control unit or in a discrete module in operative communication therewith. The 9DOF sensor in combination with the GPS sensor or a location tagged on a map (e.g. TAK-map, google maps, google earth) combined with a defined range to target (e.g. device internal or external laser range finder module) allows plotting of trajectory lines based on ballistic calculations. These trajectory lines may include a bullet's flight path and the trajectory path plotted along the terrain surface below the bullet's flight path. These two trajectory lines in combination with at least weapon and ammo ballistics data, environmental characteristics, atmospheric characteristics, terrain features along the earth surface trajectory (received from map data and/or actual UAS ISR), and target hit confirmation allow Artificial Intelligence algorithms to develop a predictable relationship between these elements and terrain features in order to improve target hit probability for future shots. For instance, during shooting training sessions or whenever a ballistic firing solution has been marked as successful, populated trajectories (air and terrain) and their target hit success are logged by the control unit 402 and stored in memory by the AI module as a successful firing solution under the given environmental, atmospheric, and terrain circumstances. Over time, the AI module adjusts suggested and calculated firing solutions based on previous successful or unsuccessful target hit experiences by comparing past, current, and future environmental and terrain conditions. The AI module may analyze recorded target engagement data and refine an algorithm for calculating a projectile flight path based on the recorded data, which may include assessing how terrain profile features such as hills, slopes, and basins manipulate wind direction and speed and subsequent effects on projectile trajectory. As an example, when the AI module has previously successfully calculated a firing solution for a given terrain ALPHA under environmental conditions ALPHA, confirmed by a successful target hit, the AI module may generate a firing solution (e.g., automatically or in response to a user input indicating a request) to hit a target in terrain BRAVO under environmental conditions BRAVO. The AI module then accesses its database from memory and identifies similarities and/or differences between the BRAVO terrain and environmental conditions and previous successful target engagements. In this example, the AI module identifies the ALPHA terrain and environmental conditions as the most supportive memory to predict and perfect the current BRAVO firing solution and applies learning experience from the ALPHA engagement to the BRAVO firing solution. The AI module can be activated or deactivated by the user.

It will be appreciated that the AI module, which is integrated into or in operative communication with a ballistics computer, may use data from a plurality of previous target engagements to refine predictive functions. The AI module is configured to record environmental condition data and projectile flight path data associated with a plurality of previous target engagements including whether the projectile hit or missed the intended target. The AI module may calculate a ballistic solution for a planned target engagement based at least in part on the recorded environmental condition data and projectile flight path data. The environmental condition data may include one or more of a wind direction, a windspeed, a humidity, a temperature, or an atmospheric pressure. In some examples, environmental condition data used by the AI module may include a terrain profile including an elevation plot along a path projected downward onto the surface of the ground from the path of the projectile. In this regard, a terrain profile may include topographical data that is retrieved from a map database (stored locally on the control unit or remotely in a cloud platform or tactical computer) or that is received from an aerial reconnaissance vehicle such as a drone in operative communication with the AI module. Projectile flight path data utilized by the AI module may include one or both of a projectile origin location (e.g., weapon location at time of firing, as provided by a GPS module or other location sensor) or a projectile terminal location (e.g., impact location of projectile, as determined using various sensors such as a range finder device, an aerial reconnaissance vehicle, and/or a camera in operative communication with the AI module), each of which may include X, Y, Z components such as a latitude, longitude, and an elevation. The projectile flight path data may also include a straight line extending between the projectile origin location and the projectile terminal location or a curved path extending between the projectile origin location and the projectile terminal location along the actual path of the projectile. The AI module may obtain a current origin location and a current target location from the control unit and may calculate a ballistic solution of a trajectory from the current origin location to the current target location by comparing recorded environmental condition data and projectile flight path data to current environmental condition data the planned projectile path. In this regard, the AI module may use historical data to refine a predictive flight path model.

In the illustrated embodiment, the atmospheric probe module 400 further includes a display device 406 removably secured to an accessory rail 412. The accessory rail 412 may be an integrated component of the atmospheric probe module 400, extending from the control unit 402 and configured to be fastened to a weapon platform, optics, or other device, or may be an existing accessory rail of such a device. In the illustrated embodiment, a picatinny rail mount is coupled to the display device 406 and includes an arm extending laterally and supporting the control unit 406.

The display device 406 is connected to the control unit 402 by a cable 408, although it should be appreciated that the control unit 402 may alternatively utilize wireless communication with the display device 406 or output from the control unit 402 may be fed directly (wired or wireless) into a display of a third-party device (e.g. laser range finder display) or an HUD. Cable 408 may provide ballistic data, sensor data, a live target vector, atmospheric data and/or power to the display device 406. The display device 406 may be configured to display a wind vector including an orientation and/or wind speed to a user on a display screen. In some examples, the display device 406 may be substantially similar to and provide similar functionality as the HUD 302 of FIGS. 16-17.

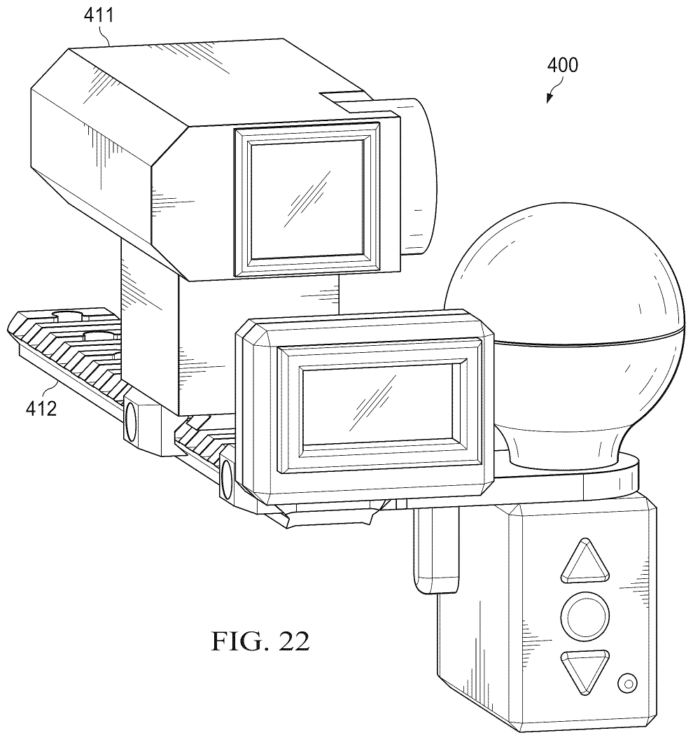

As shown in FIG. 22, an atmospheric probe module 400 may include a range finder device 411 removably secured to the accessory rail 412. The range finder device 411 may be a laser ranging device configured to provide a range to target. The range finder device 411 may be operable to provide range to target information to the display device 406 directly or may provide range information to the control unit 402 which, in turn, may provide such data to the display device 406. Data communication from the range finder device 411 to the control unit 402 and/or the display device 406 may be wired or wireless. In some embodiments, an atmospheric probe 104 may be directly integrated into the range finder device 411 which itself may be directly mounted to a weapon platform.

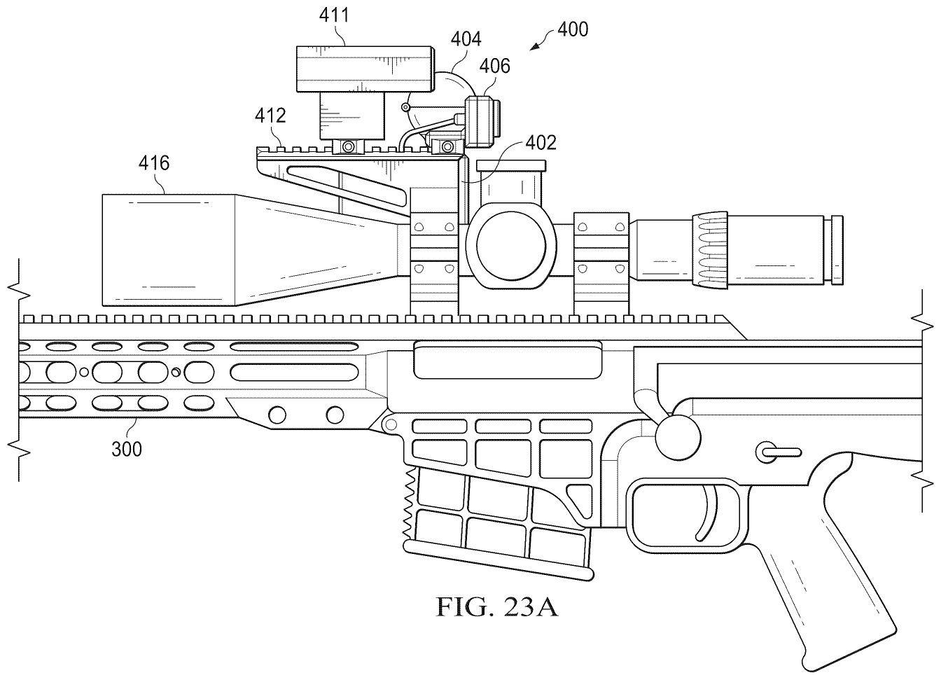

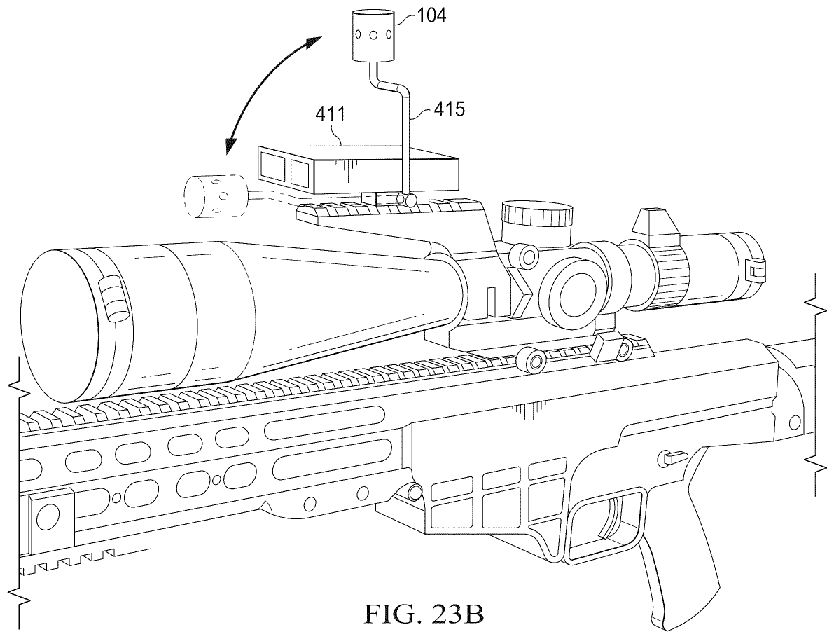

FIG. 23A illustrates an example of the atmospheric probe module 400 of FIG. 22 mounted to a weapon. In the illustrated example, the atmospheric probe module 400 (including the control unit 402, atmospheric probe 104 in cover 404, and display device 406) is mounted to accessory rail 412 of the weapon scope 416. This arrangement may be desirable for positioning the atmospheric probe 104 above the weapon and positioning the display device 406 near the line of sight of the operator with respect to the scope 416. In other examples, the module 400 may be secured to an accessory rail directly on the weapon or formed on another accessory device secured to the weapon.

FIG. 23B illustrates an example of an atmospheric probe 104 mounted to a weapon platform. In the illustrated example, the atmospheric probe 104 is mounted on a mast 415 adjacent to a range finder device 411. The mast 415 may be mountable on either side of the range finder device 411. The mast 415 may be connected to the range finder device 411 or may be mounted below the range finder device 411. The mast 415 is pivotable between a stored configuration and a deployed configuration. In the stored configuration, the mast 415 positions the atmospheric probe 104 below an upper surface of the range finder device 411. In the deployed configuration, the mast 415 positions the atmospheric probe 104 vertically above the range finder device 411 to define a highest position of the weapon platform such that conditions being measured by the atmospheric probe 104 are not affected by the weapon platform. The mast may have an offset portion between 90° bends. In this regard, the atmospheric probe 104 is positionable directly above the range finder device 411 while the range finder device 411 does not interfere with transitioning configurations of the mast 415. The mast 415 may have one or more telescoping segments to extend a length and/or an offset distance of the mast 415. This may allow for adjustment of the mast 415 to correspond to dimensions of a particular range finder device 411 being used. The atmospheric probe 104 may be wired or wirelessly coupled to the range finder device 411, or to a HUD (e.g., HUD 302 of FIG. 16) to communicate data therewith and/or to draw electrical power. In some examples, when a wired connection is used, the wire may extend through the mast 415.

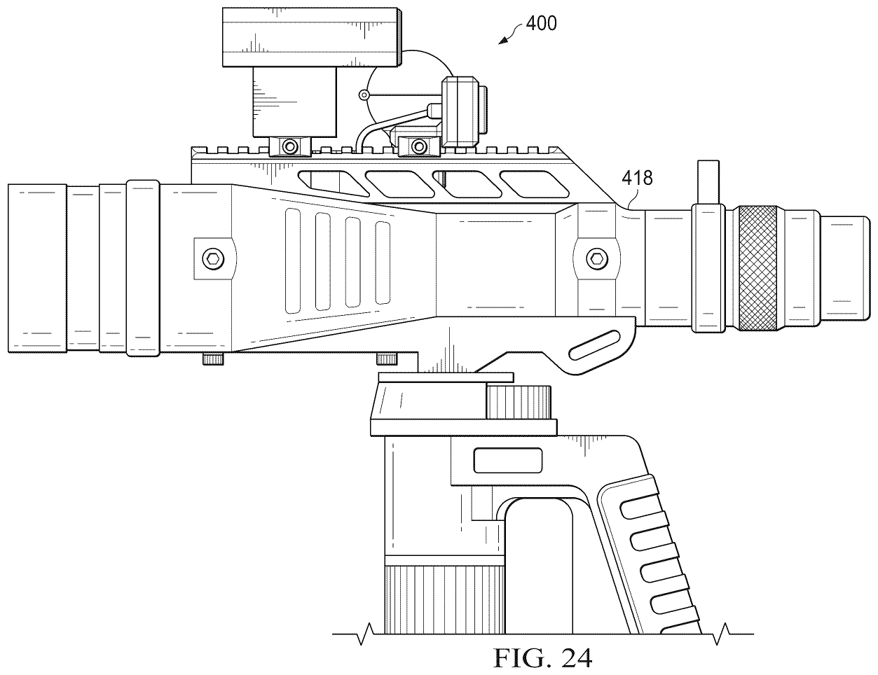

FIG. 24 illustrates an example of the atmospheric probe module 400 of FIG. 22 mounted to an optics platform. In the illustrated example, the atmospheric probe module 400 (including the control unit 402, atmospheric probe 104 in cover 404, and display device 406) is mounted to an accessory rail of the optics platform 418. The optics platform 418 may be, for example, a monocular spotting scope or binoculars.

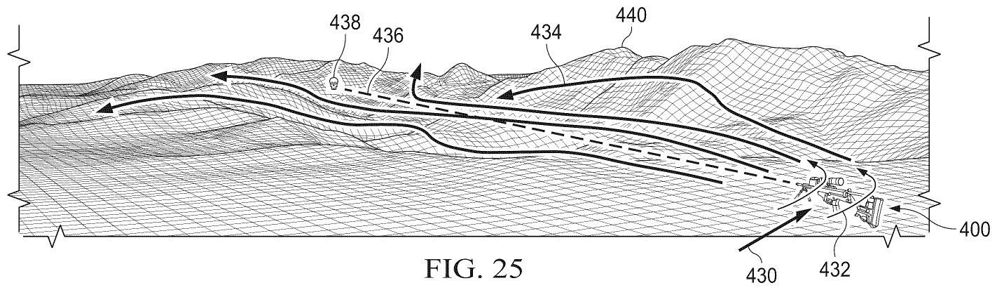

FIG. 25 illustrates an example application of terrain modeling in calculating a ballistic solution. An atmospheric probe module 400, for example, may have an active GPS module and a GPS-denied location definition feature to leverage terrain models in order to provide accurate downrange wind pattern corrections. For example, across a relatively long distance over varying terrain, wind patterns can shift dramatically. As such, the wind information available at one particular location may not be sufficient for calculating an accurate ballistic solution. However, terrain modeling may be used to improve such calculations. In some examples, module 400 may retrieve a stored terrain map or generate a terrain map. The module 400 may then locate its position within the terrain map as well as the position of a target. Utilizing one or more actual wind measurements (e.g., wind speed and wind direction) in the vicinity, the module 400 may analyze the effects of terrain features (e.g., hills, valleys, trees, lakes, canyons, etc.) to estimate wind speed and direction along other portions of the terrain map, and particularly along a vector extending from a weapon position to a target position. In FIG. 25, actual wind 430 may be measured by an atmospheric probe module 400. Using terrain map 440, the module 400 may determine a local wind component 432 and may extrapolate that local wind component 432 across the terrain as remote wind component 434. Using the local and remote wind components, the module 400 can calculate a ballistic solution for a trajectory 436 to a target 438.

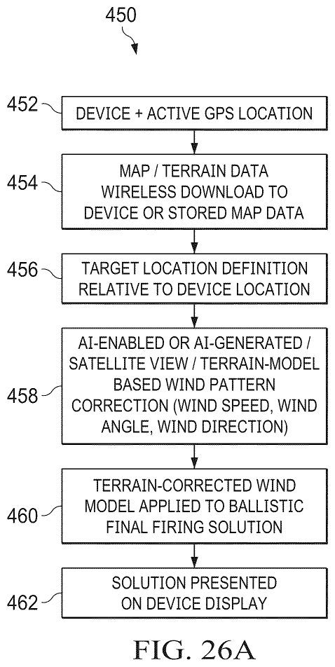

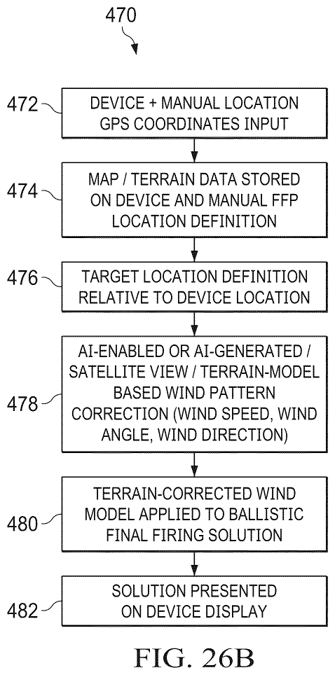

FIG. 26A illustrates an example method 450 for calculating a ballistic solution using a terrain map as discussed in relation to FIG. 25. This method 450 may be used when GPS location data is available. At 452, the atmospheric probe module 400 determines its GPS location. At 454, based on the GPS-determined location of the atmospheric probe module 400, the module downloads terrain data (e.g., a topographic map, a 3D terrain model, satellite imagery, etc.) for the region around the trajectory from a remote database or retrieves the terrain data from local memory. In some examples, robust terrain data may not be available or a sufficient data connection may not be available for expedient download. As such, the module 400 may generate terrain data using available information such as stored digital terrain elevation data (DTED). For example, artificial intelligence may be used to generate three-dimensional terrain data from a two-dimension satellite image. At 456, the target location is defined relative to the location of the module 400. This may be performed manually by the user selecting the location within the terrain data or directing the weapon platform toward the target and initiating data capture (e.g., laser distance, slope, heading, etc.). In some examples, the target location may be retrieved from a local or remote database. For example, the target location coordinates may have been previously identified and stored in a targeting database. At 458, a wind pattern customized to the terrain data is generated. This process may optionally utilize artificial intelligence to refine a modeling process based on past ballistic solutions and actual results. The wind pattern modeling may account for various environmental factors including pressure, altitude, terrain slopes, terrain materials (e.g., water, grass, trees, rocks, etc.), humidity, temperature, distances, etc. At 460, the atmospheric probe module 400 calculates a terrain-corrected ballistic solution which considers various wind speeds and directions along the trajectory as estimated by the wind pattern modeling. At 462, the ballistic solution is presented on the graphical user interface of the display. In some examples, a terrain map (e.g., contour map) and/or the wind pattern may be displayed to the user.

FIG. 26B illustrates an example method 470 for calculating a ballistic solution using a terrain map as discussed in relation to FIG. 25. This method 470 may be used when GPS location is denied or otherwise unavailable. At 472, a user manually inputs coordinates into the atmospheric probe module 400. At 474, the module downloads terrain data (e.g., a topographic map, a 3D terrain model, satellite imagery, etc.) for the region around the trajectory from a remote database or retrieves the terrain data from local memory. In some examples, robust terrain data may not be available or a sufficient data connection may not be available for expedient download. As such, the module 400 may generate terrain data using available information such as stored digital terrain elevation data (DTED). For example, artificial intelligence may be used to generate three-dimensional terrain data from a two-dimension satellite image. At 476, the target location is defined relative to the location of the module 400. This may be performed manually by the user selecting the location within the terrain data or directing the weapon platform toward the target and initiating data capture (e.g., laser distance, slope, heading, etc.). In some examples, the target location may be retrieved from a local or remote database. For example, the target location coordinates may have been previously identified and stored in a targeting database. At 478, a wind pattern customized to the terrain data is generated. This process may optionally utilize artificial intelligence to refine a modeling process based on past ballistic solutions and actual results. The wind pattern modeling may account for various environmental factors including pressure, altitude, terrain slopes, terrain materials (e.g., water, grass, trees, rocks, etc.), humidity, distances, etc. At 480, the atmospheric probe module 400 calculates a terrain-corrected ballistic solution which considers various wind speeds and directions along the trajectory as estimated by the wind pattern modeling. At 482, the ballistic solution is presented on the graphical user interface of the display. In some examples, a terrain map (e.g., contour map) and/or the wind pattern may be displayed to the user.

It should be appreciated that in addition to the examples illustrated and described above, it is contemplated that atmospheric probes may be incorporated into ground robots, unmanned underwater vehicles, floatation devices (for marine deployment) or any other deployable devices that may be suitably positioned to collect atmospheric data for calculating ballistic solutions or other uses. Although described primarily in the context of wind, the atmospheric probes described herein may be utilized to determine ground speed, air speed, or water speed of a vehicle. Additionally, each embodiment of an atmospheric probe described herein may be used to collect, in addition or as an alternative to wind speed and wind direction, atmospheric pressure, humidity, temperature, radiation, the spread of chemical, bacterial, nuclear, or other elements and particles of interest (CBRNE-levels), pollen, etc. by incorporating suitable sensors.

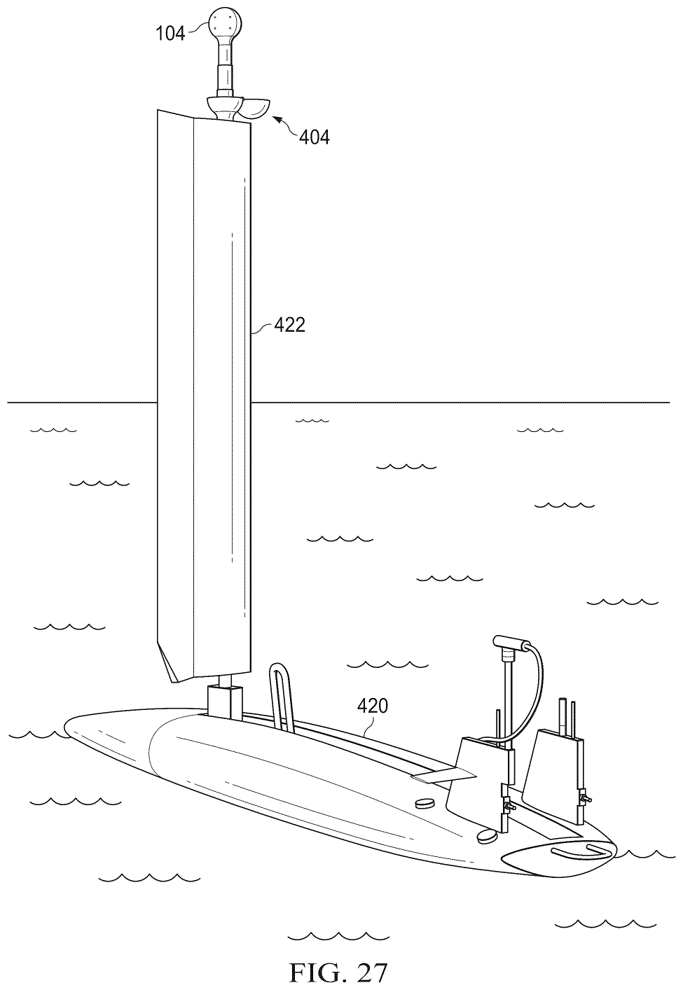

For example, FIG. 27 illustrates an example of a submersible-mounted atmospheric probe module. In the illustrated example, an autonomous underwater and surface vehicle 420 includes a deployable payload wing 422. An atmospheric probe 104 is secured to a top surface of the payload wing 422, providing an elevated position of the probe 104 when the wing is deployed. This configuration allows for atmospheric measurement above the surface of the water. With the wing 422 stowed, the atmospheric probe 104 may be secured within the cover 404 when the vehicle 420 is submersed. The cover 404 may be rated for structural integrity and water ingress prevention to depths consistent with operational depths of the vehicle 420 to protect the atmospheric probe 104 during underwater travel. For example, the cover 404 may be rated to 10 ATM, in some examples.

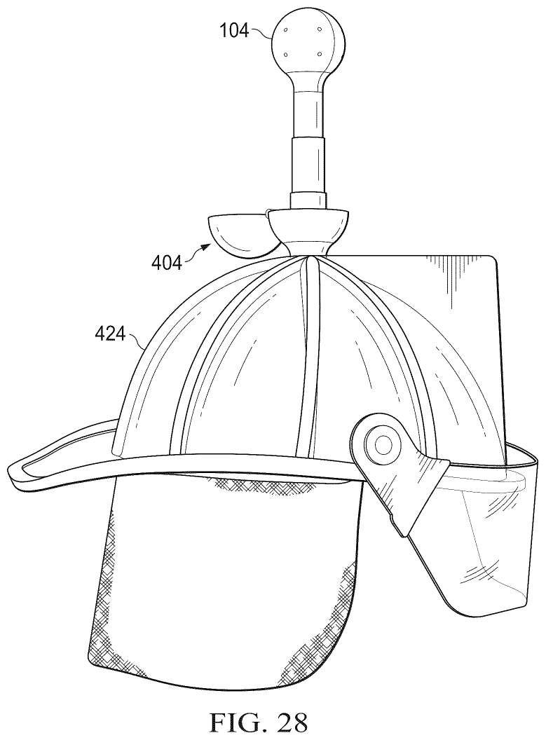

As another example of alternative uses, FIG. 28 illustrates an example of an atmospheric probe 104 mounted to personal protective equipment (“PPE”) 424. In the illustrated example, the PPE 424 is a firefighter helmet. During firefighting operations, particularly in wildfires, the probe 104 may be deployed from the cover 404 to collect atmospheric data that may be used to assess the fire, predict directional changes, and improve firefighting strategy. For instance, the AI module supports the prediction of fire pattern development based on past experience by comparing location, atmospheric, terrain, and environmental conditions from the past with current or future elemental circumstances. A team of firefighting personnel, each equipped with a probe 104, may be spread out around the fire. Atmospheric data including wind direction and magnitude may be collected by each probe 104 and relayed to a central operations platform for atmospheric monitoring. In some examples, each PPE 424 may also include a location sensor (e.g., GPS module) such that wind speed and direction from each location may be overlaid on a map in substantially real-time at the central operations platform. Additionally, each probe 104 may include a sensor configured to determine a concentration of smoke and/or oxygen in the air for relay to the central operations platform. In some examples, each PPE 424 or probe 104 may include an integrated alarm device. When smoke concentration exceeds a threshold value or oxygen concentration falls below a threshold value, the alarm device may generate a sound or light to alert the firefighter of dangerous conditions. As another example, when the central operations platform, based on aggregated atmospheric data from a plurality of probes 104, determines the wind has shifted in direction or increased in magnitude the central operations platform may transmit a signal to issue an alarm to the PPE 424 of one or more firefighters downwind of the fire, thereby alerting the firefighter(s) of increased risk. Although illustrated as a firefighter helmet, in other examples it is contemplated that PPE 424 may be a hazardous materials gas mask which may be used during a nuclear fallout or other CBRNE events. The PPE-mounted atmospheric probe 104 may be utilized to measure, map, and predict wind conditions and fallout patterns.

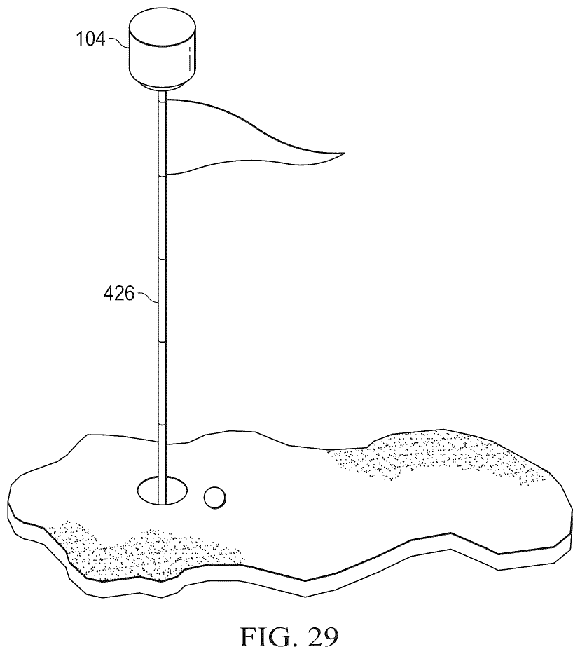

FIG. 29 illustrates an example application of an atmospheric probe in sports use. In the illustrated example, an atmospheric probe 104 is attached to a flagstick 426 on a golf course. However, it should be appreciated that the probe 104 may be suitable for use in other sports venues such as stadiums and fields. A plurality of probes 104 may be distributed around the area of play. Each probe 104 may calculate local wind speed and wind direction and report this information to a server-based database. A participant, such as a player or coach, may utilize a mobile application executed on their mobile device to access the database and retrieve local wind calculations and/or distributed wind calculations (e.g., aggregate data for the area of play).

FIG. 30 illustrates an example of a mobile device compatible atmospheric probe 104. The probe 104 may be similar to atmospheric probe 104a, 104b, or 104c discussed above, but may be fitted with a connector. For example, the probe 104 may include a USB-C or Lightning type plug configured for receipt in a port of a mobile device 428, such as a smartphone, laptop, or tablet computer. Via this connection, the probe 104 may be powered by the mobile device 428 and may transmit pressure and/or other atmospheric measurements to the mobile device 428. An application executed on the mobile device 428 may receive the raw measurement data from the probe 104 and, in turn, calculate and display the wind speed and direction on a display of the mobile device.

All relative and directional references (including up, down, upper, lower, top, bottom, side, front, rear, and so forth) are given by way of example to aid the reader's understanding of the examples described herein. They should not be read to be requirements or limitations, particularly as to the position, orientation, or use unless specifically set forth in the claims. Connection references (e.g., attached, coupled, connected, joined, and the like) are to be construed broadly and may include intermediate members between a connection of elements and relative movement between elements. As such, connection references do not necessarily infer that two elements are directly connected and in fixed relation to each other, unless specifically set forth in the claims.

The present disclosure teaches by way of example and not by limitation. Therefore, the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

1. An atmospheric measurement device, comprising:
an atmospheric probe having an aerodynamic profile defined by an outer surface;
a plurality of ports extending through the outer surface and an inner surface of the atmospheric probe; and
a plurality of pressure sensors, each pressure sensor of the plurality of pressure sensors positioned within the atmospheric probe and adjacent a respective one of the plurality of ports;
wherein each pressure sensor of the plurality of pressure sensors is configured in sealing engagement with the respective one of the plurality of ports.

2. The atmospheric measurement device of claim 1, wherein the plurality of pressure sensors is arranged about the aerodynamic profile in a manner enabling the atmospheric measurement device to determine a first angle of a wind direction through a range of 360° about a vertical axis of the atmospheric probe and a second angle of the wind direction through a range of ±30° about a horizontal axis of the atmospheric probe.

3. The atmospheric measurement device of claim 1, wherein the plurality of ports comprises a first row positioned in an upper hemisphere of the atmospheric probe and a second row positioned in a lower hemisphere of the atmospheric probe, each of the first and second rows comprising six ports spaced equidistantly apart about a vertical axis of the atmospheric probe.

4. The atmospheric measurement device of claim 3, wherein the first row is positioned approximately 20° above a reference plane separating the upper and lower hemispheres and the second row is positioned approximately 20° below the reference plane.

5. The atmospheric measurement device of claim 3, wherein the plurality of ports further comprises a third row positioned in the upper hemisphere of the atmospheric probe, the third row comprising four ports spaced equidistantly apart about the vertical axis of the atmospheric probe.

6. The atmospheric measurement device of claim 1, wherein the plurality of pressure sensors is mounted to a sensor substrate positioned within the atmospheric probe.

7. (canceled)

8. The atmospheric measurement device of claim 1, further comprising:
a hand-held housing from which the atmospheric probe extends;
a primary substrate positioned within the housing;
a processor and a memory disposed on the primary substrate, the processor configured to receive a signal from each of the plurality of pressure sensors and to calculate a wind direction and a wind speed based on the signals; and
a display configured to display the wind direction and the wind speed.

9-11. (canceled)

12. The atmospheric measurement device of claim 1, further comprising:
a cover configured to selectively enclose the atmospheric probe.

13-14. (canceled)

15. An unmanned aerial vehicle, comprising:
a fuselage;
at least one fixed wing;
a propulsion system; and
the atmospheric measurement device of claim 1.

16-18. (canceled)

19. An unmanned aerial vehicle, comprising:
a fuselage;
a plurality of rotary wings; and
the atmospheric measurement device of claim 1.

20-24. (canceled)

25. A targeting system, comprising:
a weapon;
a ballistics computer; and
a plurality of nodes configured to be deployed across an area of operation, at least one node of the plurality of nodes comprising the atmospheric measurement device of claim 1, each node of the plurality of nodes configured to obtain atmospheric data at a respective deployment location and transmit the atmospheric data to the ballistics computer, the ballistics computer configured to calculate a ballistic solution based on aggregated atmospheric data obtained from the plurality of nodes.

26. An unmanned aerial vehicle, comprising:
a body;
a plurality of pressure sensors integrated into the body at a plurality of distributed ports; and
a processor configured to obtain pressure data from the plurality of pressure sensors and to calculate a wind speed and a wind direction based on the pressure data and a known location of each pressure sensor of the plurality of pressure sensors in relation to the body.

27. The unmanned aerial vehicle of claim 26, wherein the body comprises two or more structures selected from a group consisting of:
a fuselage;
at least one wing;
at least one more housing;
at least one rotor hub; and
a vertical stabilizer;
wherein the plurality of pressure sensors is distributed across a plurality of the two or more structures.

28. The unmanned aerial vehicle of claim 26, wherein the body comprises a fuselage and at least one wing, wherein at least a portion of a first group of pressure sensors of the plurality of pressure sensors is disposed across a leading side of the body and at least a portion of a second group of pressure sensors of the plurality of pressure sensors is disposed across a tailing side of the body.

29-35. (canceled)

36. A weapon system, comprising:
a firearm;
a ballistics computer; and
an atmospheric measurement device mounted to the firearm, the atmospheric measurement device comprising:
an atmospheric probe;
a plurality of ports extending through an outer surface of the atmospheric probe; and
a plurality of pressure sensors, each pressure sensor of the plurality of pressure sensors positioned within the atmospheric probe and adjacent a respective one of the plurality of ports.

37. The weapon system of claim 36, wherein the atmospheric measurement device is configured to collect raw data regarding an atmospheric wind and transmit the raw data to the ballistics computer.

38. The weapon system of claim 36, wherein the atmospheric measurement device is configured to calculate a wind speed and a wind direction of an atmospheric wind and transmit the calculated wind speed and wind direction to the ballistics computer.

39-47. (canceled)

48. The weapon system of claim 36, wherein the ballistics computer is configured to receive atmospheric data and position data from a plurality of atmospheric sensors, including the atmospheric measurement device mounted to the firearm, and to calculate a ballistic solution for a projectile based on the atmospheric data and position data.

49-51. (canceled)

52. The weapon system of claim 36, further comprising an artificial intelligence module in operative communication with the ballistics computer, wherein the artificial intelligence module is configured to record environmental condition data and projectile flight path data associated with a plurality of historical target engagements and to calculate a ballistic solution based at least in part on the recorded environmental condition data and projectile flight path data.

53. The weapon system of claim 52, wherein the artificial intelligence module is configured to calculate the ballistic solution further based on atmospheric data received from the atmospheric measurement device.

54-56. (canceled)
